(19) United States
(12) Patent Application Publication
(10) Pub. No.: US 2022/0338204 A1
(43) Pub. Date: Oct. 20, 2022

(54) METHOD AND APPARATUS FOR PERFORMING COMMUNICATION ON BASIS OF ONE OR MORE FREQUENCIES

(71) Applicant: LG ELECTRONICS INC., Seoul (KR)

(72) Inventors: Sunghoon JUNG, Seoul (KR); Hanbyul SEO, Seoul (KR); Seungmin LEE, Seoul (KR)

(73) Assignee: LG ELECTRONICS INC., Seoul (KR)

(21) Appl. No.: 17/268,402

(22) PCT Filed: Oct. 31, 2019
(86) PCT No.: PCT/KR2019/014637

§ 371 Date: Feb. 12, 2021

(30) Foreign Application Priority Data
Oct. 31, 2018 (KR) 10-2018-0131745

(51) Int. Cl. H04W 72/08

(52) U.S. Cl. CPC H04W 72/087

(57) ABSTRACT

Provided are a method of performing transmission by a first device [100], and an apparatus for supporting same. The method may comprise the steps of: determining the number of frequencies related to transmission of first information on the basis of a delay deadline of the first information; and transmitting the first information to a second device [200] on one or more frequencies.

### BACKGROUND OF THE DISCLOSURE

### Field of the Disclosure

The present disclosure relates to a wireless communication system.

### Related Art

A wireless communication system is a multiple access system that supports communication of multiple users by sharing available system resources (e.g. a bandwidth, transmission power, etc.) among them. Examples of multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi-Carrier Frequency Division Multiple Access (MC-FDMA) system.

Meanwhile, in a smart factory, ICT technologies such as IoT, big data, and cloud may be applied to the pre-production stage. In the smart factory, tasks such as remote control of various facilities or robots for product production, real-time collection of process status information, work environment monitoring and control through various sensors, and remote monitoring using VR can be performed. The smart factory is a 5G application field that is most anticipated in conjunction with the 4th industrial revolution. Communication to be used in the smart factory should provide hyper connectivity while satisfying high reliability and low latency, which can be referred to as industrial internet of things (IIoT).

### SUMMARY OF THE DISCLOSURE

### Technical Objects

Meanwhile, according to the feedback-based retransmission method, in case that it is unclear whether or not retransmission by the first device (100) is successful, a problem of exceeding a QoS requirement (e.g., allowed delay time) of information may occur. On the other hand, according to a method in which the first device (100) performs transmission using a plurality of frequencies, a problem of wasting transmission resources may occur.

Therefore, according to various embodiments of the present disclosure, there is need to propose a method of transmitting the information based on different transmission methods according to time, in consideration of latency requirement of the information to be transmitted by the first device 100, and an apparatus supporting the same.

### Technical Solutions

In an embodiment, a method for performing transmission by a first device (100) is provided. The method may comprise: determining a number of frequencies related to transmission of first information based on a delay deadline of the first information; and transmitting the first information to a second device (200) on one or more frequencies.

In an embodiment, a first device (100) performing transmission is provided. The first device (100) may comprise: one or more memories; one or more transceivers; and one or more processors connected to the one or more memories and the one or more transceivers. The one or more processors may be configured to: determine a number of frequencies related to transmission of first information based on a delay deadline of the first information; and transmit the first information to a second device (200) on one or more frequencies.

### Effects of the Disclosure

Transmission can be performed efficiently.

### BRIEF DESCRIPTION OF THE DRAWINGS

FIG. 1 shows a structure of an LTE system, in accordance with an embodiment of the present disclosure.

FIG. 2 shows a radio protocol architecture of a user plane, in accordance with an embodiment of the present disclosure.

FIG. 3 shows a radio protocol architecture of a control plane, in accordance with an embodiment of the present disclosure.

FIG. 4 shows a structure of an NR system, in accordance with an embodiment of the present disclosure.

FIG. 5 shows a functional division between an NG-RAN and a 5GC, in accordance with an embodiment of the present disclosure.

FIG. 6 shows a structure of a radio frame of an NR, in accordance with an embodiment of the present disclosure.

FIG. 7 shows a structure of a slot of an NR frame, in accordance with an embodiment of the present disclosure.

FIG. 8 shows an example of a BWP, in accordance with an embodiment of the present disclosure.

FIG. 9 shows a protocol stack for a SL communication, in accordance with an embodiment of the present disclosure.

FIG. 10 shows a protocol stack for a SL communication, in accordance with an embodiment of the present disclosure.

FIG. 11 shows a UE performing V2X or SL communication, in accordance with an embodiment of the present disclosure.

FIG. 12 shows a resource unit for V2X or SL communication, in accordance with an embodiment of the present disclosure.

FIG. 13 shows procedures of a UE performing V2X or SL communication according to a transmission mode (TM), in accordance with an embodiment of the present disclosure.

FIG. 14 shows a method of selecting a transmission resource by a UE, in accordance with an embodiment of the present disclosure.

FIG. 15 shows three different cast types, in accordance with an embodiment of the present disclosure.

FIG. 16 shows a method in which the first device (100) transmits information using one or more frequencies, in accordance with an embodiment of the present disclosure.

FIG. 17 shows a method in which the first device (100) transmits information using one frequency, in accordance with an embodiment of the present disclosure.

FIG. 18 shows a method in which the first device (100) transmits information using two frequencies, in accordance with an embodiment of the present disclosure.

FIG. 19 shows a method in which the first device (100) performs transmission using one or more frequencies, in accordance with an embodiment of the present disclosure.

FIG. 20 shows a communication system 1, in accordance with an embodiment of the present disclosure.

FIG. 21 shows wireless devices, in accordance with an embodiment of the present disclosure.

FIG. 22 shows a signal process circuit for a transmission signal, in accordance with an embodiment of the present disclosure.

FIG. 23 shows another example of a wireless device, in accordance with an embodiment of the present disclosure.

FIG. 24 shows a hand-held device, in accordance with an embodiment of the present disclosure.

FIG. 25 shows a vehicle or an autonomous vehicle, in accordance with an embodiment of the present disclosure.

FIG. 26 shows a vehicle, in accordance with an embodiment of the present disclosure.

FIG. 27 shows an XR device, in accordance with an embodiment of the present disclosure.

FIG. 28 shows a robot, in accordance with an embodiment of the present disclosure.

FIG. 29 shows an AI device, in accordance with an embodiment of the present disclosure.

### DESCRIPTION OF EXEMPLARY EMBODIMENTS

In various embodiments of the present disclosure, it shall be interpreted that “I” and “,” indicate “and/or”. For example, “A/B” may mean “A and/or B”. Additionally, “A, B” may also mean “A and/or B”. Moreover, “A/B/C” may mean “at least one of A, B and/or C”. Furthermore, “A, B, C” may also mean “at least one of A, B and/or C”.

Furthermore, in various embodiments of the present disclosure, it shall be interpreted that “or” indicates “and/or”. For example, “A or B” may include “only A”, “only B”, and/or “both A and B”. In other words, in various embodiments of the present disclosure, it shall be interpreted that “or” indicates “additionally or alternatively”.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features of the present disclosure will not be limited only to this.

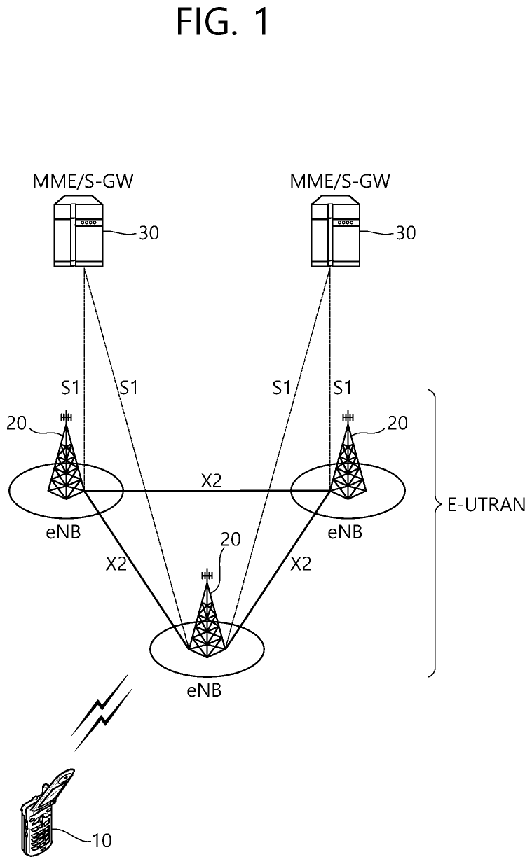

FIG. 1 shows a structure of an LTE system, in accordance with an embodiment of the present disclosure. This may also be referred to as an Evolved-UMTS Terrestrial Radio Access Network (E-UTRAN), or a Long Term Evolution (LTE)/LTE-A system.

Referring to FIG. 1, the E-UTRAN includes a base station (BS) 20, which provides a control plane and a user plane to a user equipment (UE) 10. The UE 10 may be fixed or mobile and may also be referred to by using different terms, such as Mobile Station (MS), User Terminal (UT), Subscriber Station (SS), Mobile Terminal (MT), wireless device, and so on. The base station 20 refers to a fixed station that communicates with the UE 10 and may also be referred to by using different terms, such as evolved-NodeB (eNB), Base Transceiver System (BTS), Access Point (AP), and so on.

The base stations 20 are interconnected to one another through an X2 interface. The base stations 20 are connected to an Evolved Packet Core (EPC) 30 through an S1 interface. More specifically, the base station 20 are connected to a Mobility Management Entity (MME) through an S1-MME interface and connected to Serving Gateway (S-GW) through an S1-U interface.

The EPC 30 is configured of an MME, an S-GW, and a Packet Data Network-Gateway (P-GW). The MME has UE access information or UE capability information, and such information may be primarily used in UE mobility management. The S-GW corresponds to a gateway having an E-UTRAN as its endpoint. And, the P-GW corresponds to a gateway having a Packet Data Network (PDN) as its endpoint.

Layers of a radio interface protocol between the UE and the network may be classified into a first layer (L1), a second layer (L2), and a third layer (L3) based on the lower three layers of an open system interconnection (OSI) model, which is well-known in the communication system. Herein, a physical layer belonging to the first layer provides a physical channel using an Information Transfer Service, and a Radio Resource Control (RRC) layer, which is located in the third layer, executes a function of controlling radio resources between the UE and the network. For this, the RRC layer exchanges RRC messages between the UE and the base station.

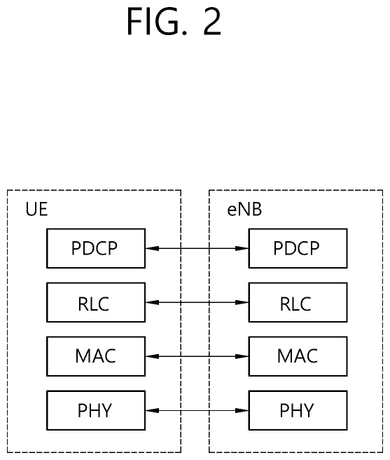

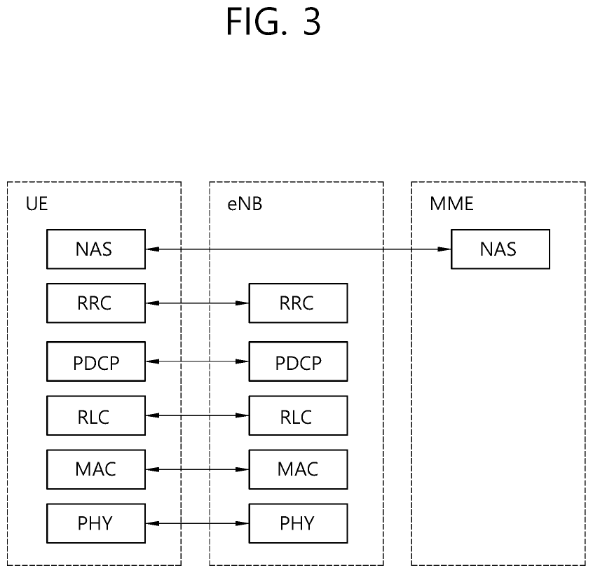

FIG. 2 shows a radio protocol architecture of a user plane, in accordance with an embodiment of the present disclosure. FIG. 3 shows a radio protocol architecture of a control plane, in accordance with an embodiment of the present disclosure. The user plane is a protocol stack for user data transmission, and the control plane is a protocol stack for control signal transmission.

Referring to FIG. 2 and FIG. 3, a physical (PHY) layer belongs to the L1. A physical (PHY) layer provides an information transfer service to a higher layer through a physical channel. The PHY layer is connected to a medium access control (MAC) layer. Data is transferred (or transported) between the MAC layer and the PHY layer through a transport channel. The transport channel is sorted (or categorized) depending upon how and according to which characteristics data is being transferred through the radio interface.

Between different PHY layers, i.e., a PHY layer of a transmitter and a PHY layer of a receiver, data is transferred through the physical channel. The physical channel may be modulated by using an orthogonal frequency division multiplexing (OFDM) scheme and uses time and frequency as radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure various quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

The radio resource control (RRC) layer is defined only in a control plane. And, the RRC layer performs a function of controlling logical channel, transport channels, and physical channels in relation with configuration, re-configuration, and release of radio bearers. The RB refers to a logical path being provided by the first layer (PHY layer) and the second layer (MAC layer, RLC layer, Packet Data Convergence Protocol (PDCP) layer) in order to transport data between the UE and the network.

Functions of a PDCP layer in the user plane include transfer, header compression, and ciphering of user data. Functions of a PDCP layer in the control plane include transfer and ciphering/integrity protection of control plane data.

The configuration of the RB refers to a process for specifying a radio protocol layer and channel properties in order to provide a particular service and for determining respective detailed parameters and operation methods. The RB may then be classified into two types, i.e., a signaling radio bearer (SRB) and a data radio bearer (DRB). The SRB is used as a path for transmitting an RRC message in the control plane, and the DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the base station is released.

Downlink transport channels transmitting (or transporting) data from a network to a UE include a Broadcast Channel (BCH) transmitting system information and a downlink Shared Channel (SCH) transmitting other user traffic or control messages. Traffic or control messages of downlink multicast or broadcast services may be transmitted via the downlink SCH or may be transmitted via a separate downlink Multicast Channel (MCH). Meanwhile, uplink transport channels transmitting (or transporting) data from a UE to a network include a Random Access Channel (RACH) transmitting initial control messages and an uplink Shared Channel (SCH) transmitting other user traffic or control messages.

Logical channels existing at a higher level than the transmission channel and being mapped to the transmission channel may include a Broadcast Control Channel (BCCH), a Paging Control Channel (PCCH), a Common Control Channel (CCCH), a Multicast Control Channel (MCCH), a Multicast Traffic Channel (MTCH), and so on.

A physical channel is configured of a plurality of OFDM symbols in the time domain and a plurality of sub-carriers in the frequency domain. One subframe is configured of a plurality of OFDM symbols in the time domain. A resource block is configured of a plurality of OFDM symbols and a plurality of sub-carriers in resource allocation units. Additionally, each subframe may use specific sub-carriers of specific OFDM symbols (e.g., first OFDM symbol) of the corresponding subframe for a Physical Downlink Control Channel (PDCCH), i.e., L1/L2 control channels. A Transmission Time Interval (TTI) refers to a unit time of a subframe transmission.

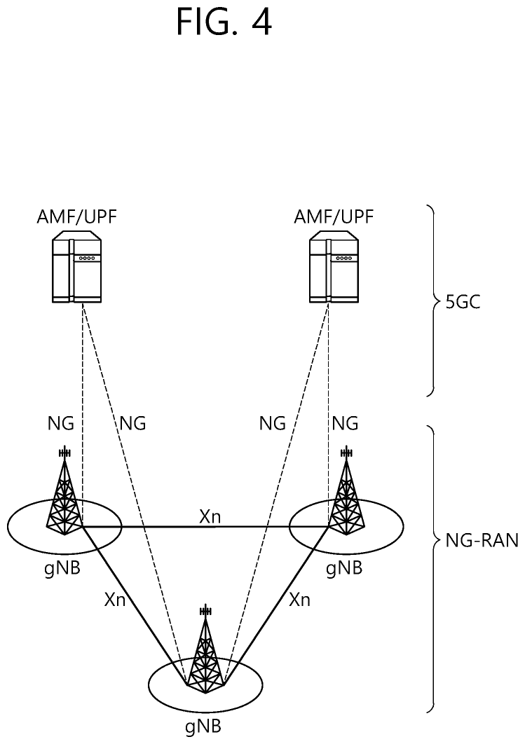

FIG. 4 shows a structure of an NR system, in accordance with an embodiment of the present disclosure.

Referring to FIG. 4, a Next Generation-Radio Access Network (NG-RAN) may include a next generation-Node B (gNB) and/or eNB providing a user plane and control plane protocol termination to a user. FIG. 4 shows a case where the NG-RAN includes only the gNB. The gNB and the eNB are connected to one another via Xn interface. The gNB and the eNB are connected to one another via 5^{th} Generation (5G) Core Network (5GC) and NG interface. More specifically, the gNB and the eNB are connected to an access and mobility management function (AMF) via NG-C interface, and the gNB and the eNB are connected to a user plane function (UPF) via NG-U interface.

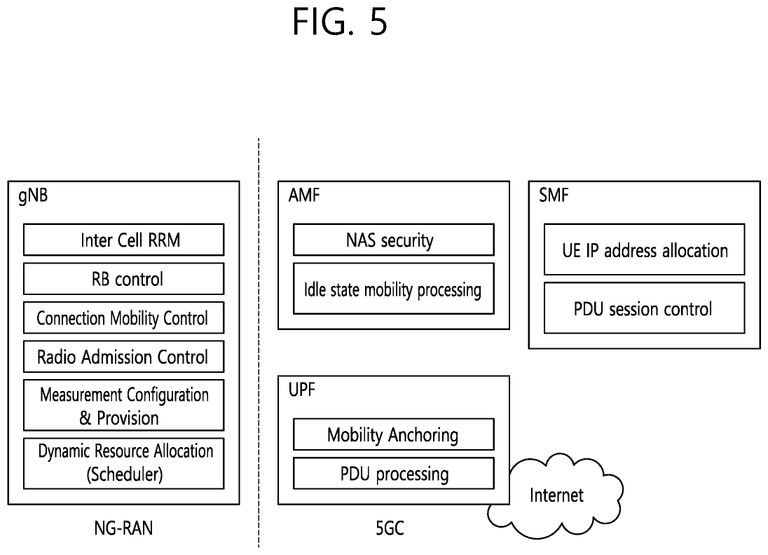

FIG. 5 shows a functional division between an NG-RAN and a 5GC, in accordance with an embodiment of the present disclosure.

Referring to FIG. 5, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

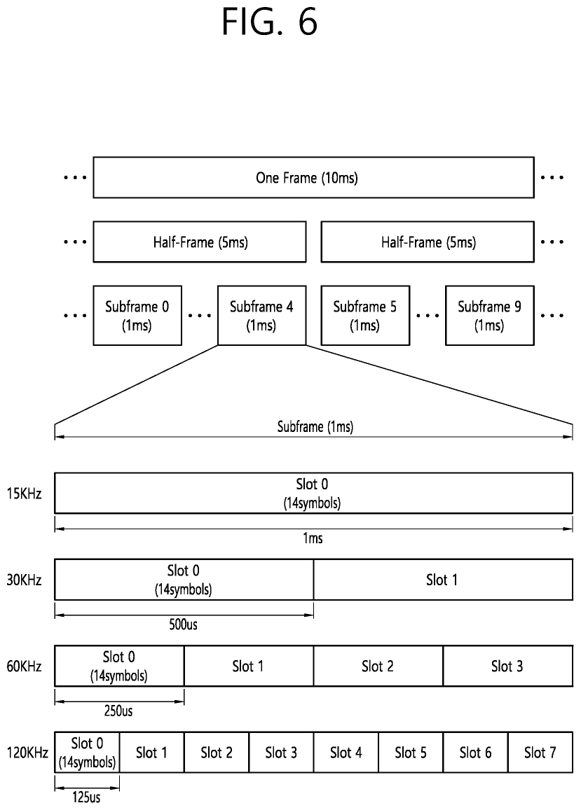

FIG. 6 shows a structure of a radio frame of an NR, in accordance with an embodiment of the present disclosure.

Referring to FIG. 6, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe,u}ₛₗₒₜ) in accordance with an SCS configuration (u), in a case where a normal CP is used.

TABLE 1

| SCS (15*2^{u}) | | N_{symb}^{slot} | Nₛₗₒₜ^{frame,u} | Nₛₗₒₜ^{subframe,u} |
|---|---|---|---|---|
| 15 KHz | (u = 0) | 14 | 10 | 1 |
| 30 KHz | (u = 1) | 14 | 20 | 2 |
| 60 KHz | (u = 2) | 14 | 40 | 4 |
| 120 KHz | (u = 3) | 14 | 80 | 8 |
| 240 KHz | (u = 4) | 14 | 160 | 16 |

Table 2 shows an example of a number of symbols per slot, a number of slots per frame, and a number of slots per subframe in accordance with the SCS, in a case where an extended CP is used.

TABLE 2

| SCS (15*2^{u}) | N_{symb}^{slot} | Nₛₗₒₜ^{frame,u} | Nₛₗₒₜ^{subframe,u} |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting various 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | Subcarrier | |
|---|---|---|---|
| designation | frequency range | Spacing (SCS) | |
| FR1 | 450 MHz-6000 MHz | 15, 30, 60 | kHz |
| FR2 | 24250 MHz-52600 MHz | 60, 120, 240 | kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 may include an unlicensed band. The unlicensed band may be used for various purposes, e.g., the unlicensed band for vehicle-specific communication (e.g., autonomous driving).

TABLE 4

| Frequency Range | Corresponding | Subcarrier | |
|---|---|---|---|
| designation | frequency range | Spacing (SCS) | |
| FR1 | 410 MHz-7125 MHz | 15, 30, 60 | kHz |
| FR2 | 24250 MHz-52600 MHz | 60, 120, 240 | kHz |

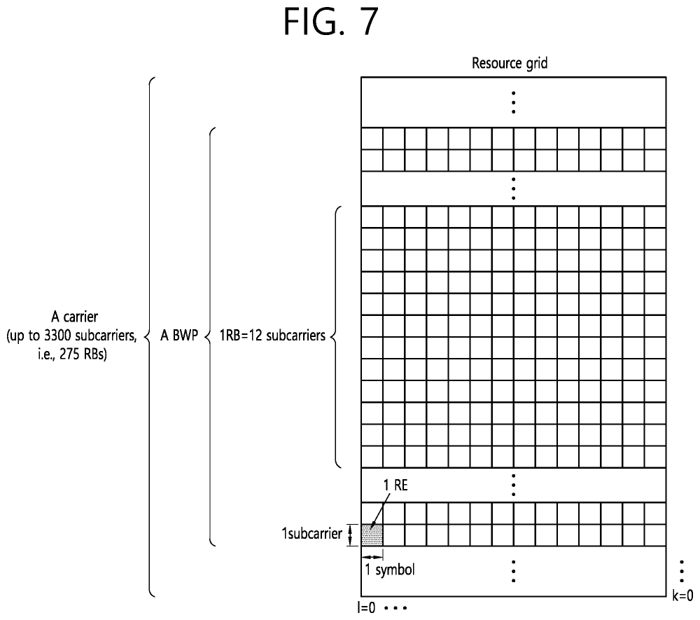

FIG. 7 shows a structure of a slot of an NR frame, in accordance with an embodiment of the present disclosure.

Referring to FIG. 7, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Hereinafter, a Bandwidth Part (BWP) and a carrier will be described in detail.

The Bandwidth Part (BWP) may be a continuous set of physical resource blocks (PRBs) within a given numerology. The PRB may be selected from a continuous partial set of a common resource block (CRB) for a given numerology on a given carrier.

When using Bandwidth Adaptation (BA), a receiving bandwidth and a transmitting bandwidth of a user equipment (UE) are not required to be as wide (or large) as the bandwidth of the cell, and the receiving bandwidth and the transmitting bandwidth of the UE may be controlled (or adjusted). For example, the UE may receive information/configuration for bandwidth control (or adjustment) from a network/base station. In this case, the bandwidth control (or adjustment) may be performed based on the received information/configuration. For example, the bandwidth control (or adjustment) may include reduction/expansion of the bandwidth, position change of the bandwidth, or change in subcarrier spacing of the bandwidth.

For example, the bandwidth may be reduced during a duration with little activity in order to save power. For example, a position of the bandwidth may be relocated (or moved) from a frequency domain. For example, the position of the bandwidth may be relocated (or moved) from a frequency domain in order to enhance scheduling flexibility. For example, subcarrier spacing of the bandwidth may be changed. For example, the subcarrier spacing of the bandwidth may be changed in order to authorize different services. A subset of a total cell bandwidth of a cell may be referred to as a Bandwidth Part (BWP). BA may be performed when a base station/network configures BWPs to the UE, and when the base station/network notifies the BWP that is currently in an active state, among the BWPs, to the UE.

For example, the BWP may be one of an active BWP, an initial BWP, and/or a default BWP. For example, the UE may not monitor a downlink radio link quality in a DL BWP other than the active DL BWP within a primary cell (PCell). For example, the UE may not receive a PDCCH, a PDSCH or a CSI-RS (excluding only the RRM) from outside of the active DL BWP. For example, the UE may not trigger a Channel State Information (CSI) report for an inactive DL BWP. For example, the UE may not transmit a PUCCH or a PUSCH from outside of an inactive DL BWP. For example, in case of a downlink, an initial BWP may be given as a continuous RB set for an RMSI CORESET (that is configured by a PBCH). For example, in case of an uplink, an initial BWP may be given by a SIB for a random access procedure. For example, a default BWP may be configured by a higher layer. For example, an initial value of a default BWP may be an initial DL BWP. For energy saving, if the UE fails to detect DCI during a predetermined period of time, the UE may switch the active BWP of the UE to a default BWP.

Meanwhile, a BWP may be defined for the SL. The same SL BWP may be used for transmission and reception. For example, a transmitting UE may transmit an SL channel or SL signal within a specific BWP, and a receiving UE may receive an SL channel or SL signal within the same specific BWP. In a licensed carrier, the SL BWP may be defined separately from a Uu BWP, and the SL BWP may have a separate configuration signaling from the Uu BWP. For example, the UE may receive a configuration for an SL BWP from the base station/network. The SL BWP may be configured (in advance) for an out-of-coverage NR V2X UE and an RRC_IDLE UE. For a UE operating in the RRC_CONNECTED mode, at least one SL BWP may be activated within a carrier.

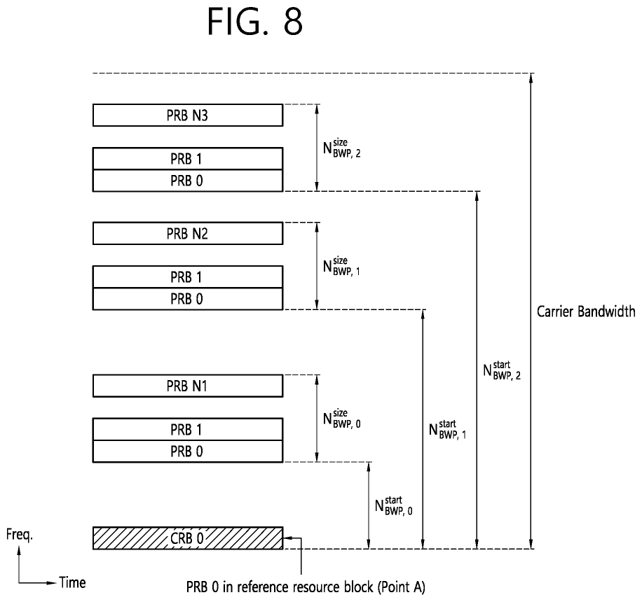

FIG. 8 shows an example of a BWP, in accordance with an embodiment of the present disclosure. In the embodiment of FIG. 8, it is assumed that three BWPs exist.

Referring to FIG. 8, a common resource block (CRB) may be a carrier resource block that is numerated from one end of a carrier band to another end. And, a PRB may be a resource block that is numerated within each BWP. Point A may indicate a common reference point for a resource block grid.

A BWP may be configured by Point A, an offset (N^{start}_{BWP}) from Point A, and a bandwidth (N^{size}_{BWP}). For example, Point A may be an external reference point of a PRB of a carrier having subcarrier 0 of all numerologies (e.g., all numerologies being supported by the network within the corresponding carrier) aligned therein. For example, the offset may be a PRB distance between a lowest subcarrier within a given numerology and Point A. For example, the bandwidth may be a number of PRBs within the given numerology.

Hereinafter, V2X or SL communication will be described.

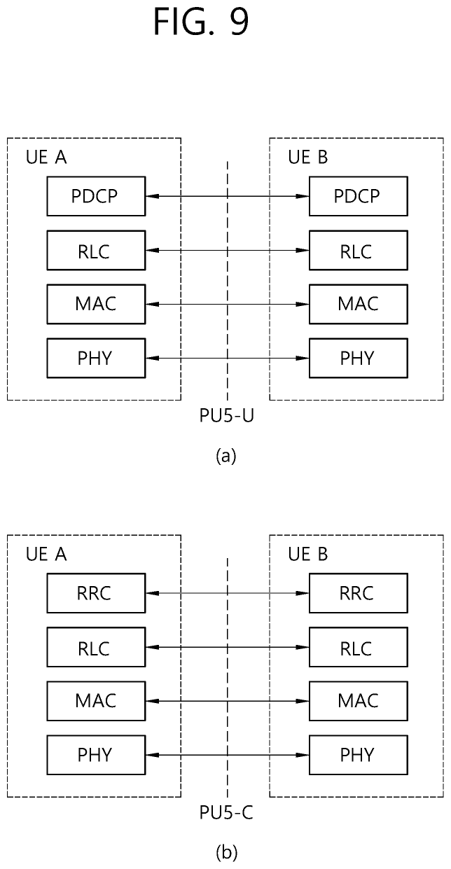

FIG. 9 shows a protocol stack for a SL communication, in accordance with an embodiment of the present disclosure. More specifically, (a) of FIG. 9 shows a user plane protocol stack of LTE, and (b) of FIG. 9 shows a control plane protocol stack of LTE.

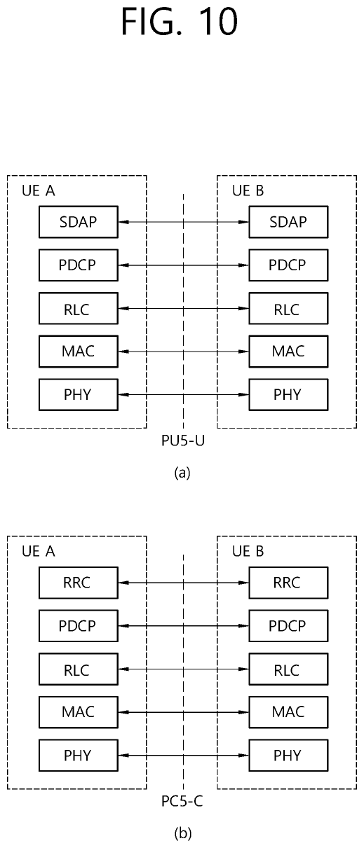

FIG. 10 shows a protocol stack for a SL communication, in accordance with an embodiment of the present disclosure. More specifically, (a) of FIG. 10 shows a user plane protocol stack of NR, and (b) of FIG. 10 shows a control plane protocol stack of NR.

Hereinafter, SL Synchronization Signal (SLSS) and synchronization information will be described.

SLSS is a SL specific sequence, which may include a Primary Sidelink Synchronization Signal (PSSS) and a Secondary Sidelink Synchronization Signal (SSSS). The PSSS may also be referred to as a Sidelink Primary Synchronization Signal (S-PSS), and the SSSS may also be referred to as a Sidelink Secondary Synchronization Signal (S-SSS).

A Physical Sidelink Broadcast Channel (PSBCH) may be a (broadcast) channel through which basic (system) information that should first be known by the user equipment (UE) before transmitting and receiving SL signals. For example, the basic information may be information related to SLSS, a Duplex mode (DM), Time Division Duplex Uplink/Downlink (TDD UL/DL) configuration, information related to a resource pool, application types related to SLSS, a subframe offset, broadcast information, and so on.

The S-PSS, the S-SSS, and the PSBCH may be included in a block format (e.g., a SL SS/PSBCH block, hereinafter referred to as Sidelink-Synchronization Signal Block (S-SSB)). The S-SSB may have the same numerology (i.e., SCS and CP length) as a Physical Sidelink Control Channel (PSCCH)/Physical Sidelink Shared Channel (PSSCH) within the carrier, and a transmission bandwidth may exist within a (pre-)configured SL Bandwidth Part (BWP). And, a frequency position of the S-SSB may be (pre-)configured. Therefore, the UE is not required to perform a hypothesis detection in order to discover the S-SSB in the carrier.

Each SLSS may have a physical layer SL synchronization identity (ID), and the respective value may be equal to any one value ranging from 0 to 335. Depending upon one of the above-described values that is used, a synchronization source may also be identified. For example, values of 0, 168, 169 may indicate global navigation satellite systems (GNSS), values from 1 to 167 may indicate base stations, and values from 170 to 335 may indicate that the source is outside of the coverage. Alternatively, among the physical layer SL synchronization ID values, values 0 to 167 may correspond to value being used by a network, and values from 168 to 335 may correspond to value being used outside of the network coverage.

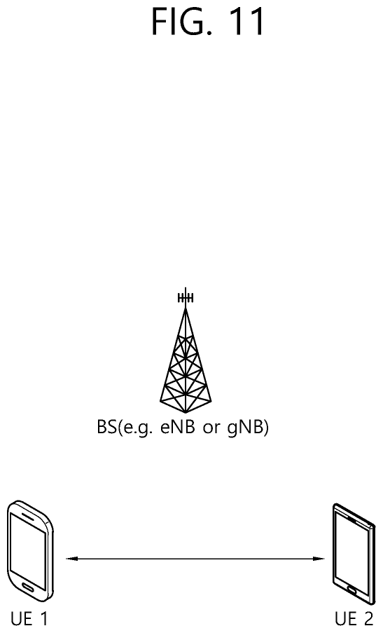

FIG. 11 shows a UE performing V2X or SL communication, in accordance with an embodiment of the present disclosure.

Referring to FIG. 11, in V2X/SL communication, the term terminal may mainly refer to a terminal (or equipment) used by a user. However, in case a network equipment, such as a base station, transmits and receives signals in accordance with a communication scheme between the network equipment and a user equipment (UE) (or terminal), the base station may also be viewed as a type of user equipment (or terminal).

User equipment 1 (UE1) may select a resource unit corresponding to a specific resource within a resource pool, which refers to a set of resources, and UE1 may then be operated so as to transmit a SL signal by using the corresponding resource unit. User equipment 2 (UE2), which is to a receiving UE, may be configured with a resource pool to which UE1 can transmit signals, and may then detect signals of UE1 from the corresponding resource pool.

Herein, in case UE1 is within a connection range of the base station, the base station may notify the resource pool. Conversely, in case UE1 is outside a connection range of the base station, another UE may notify the resource pool or a pre-determined resource may be used.

Generally, a resource pool may be configured in a plurality of resource units, and each UE may select one resource unit or a plurality of resource units and may use the selected resource unit(s) for its SL signal transmission.

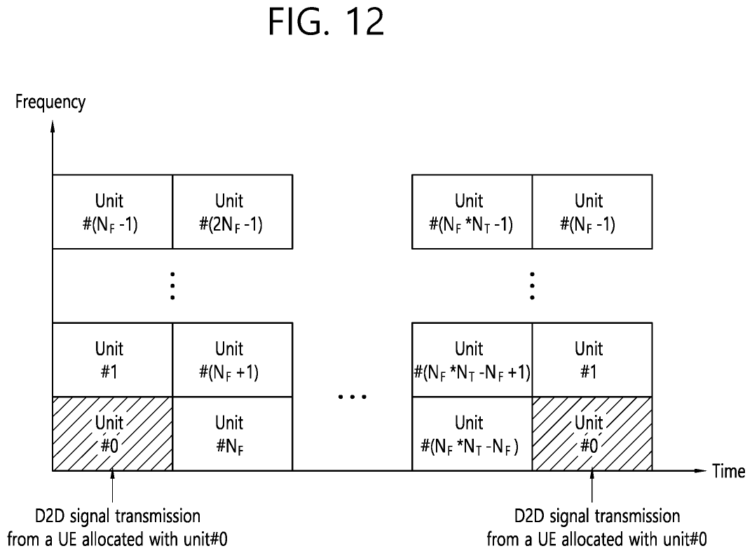

FIG. 12 shows a resource unit for V2X or SL communication, in accordance with an embodiment of the present disclosure.

Referring to FIG. 12, the total frequency resources of the resource pool may be divided into N_{F} number of resource units, the total time resources of the resource pool may be divided into N_{T} number of resource units. Therefore, a total of N_{F}*N_{T} number of resource units may be defined in the resource pool. FIG. 12 shows an example of a case where the corresponding resource pool is repeated at a cycle of N_{T} number of subframes.

As shown in FIG. 12, one resource unit (e.g., Unit #0) may be periodically and repeatedly indicated. Alternatively, in order to achieve a diversity effect in the time or frequency level (or dimension), an index of a physical resource unit to which a logical resource unit is mapped may be changed to a pre-determined pattern in accordance with time. In such resource unit structure, the resource pool may refer to a set of resource units that can be used for a transmission that is performed by a user equipment (UE), which intends to transmit SL signals.

The resource pool may be segmented to multiple types. For example, depending upon the content of a SL signal being transmitted from each resource pool, the resource pool may be divided as described below.

(1) Scheduling Assignment (SA) may correspond to a signal including information, such as a position of a resource that is used for the transmission of a SL data channel, a Modulation and Coding Scheme (MCS) or Multiple Input Multiple Output (MIMO) transmission scheme needed for the modulation of other data channels, a Timing Advance (TA), and so on. The SA may also be multiplexed with SL data within the same resource unit and may then be transmitted, and, in this case, an SA resource pool may refer to a resource pool in which the SA is multiplexed with the SL data and then transmitted. The SA may also be referred to as a SL control channel.

(2) A Physical Sidelink Shared Channel (PSSCH) may be a resource pool that is used by a transmitting UE for transmitting user data. If the SA is multiplexed with SL data within the same resource unit and then transmitted, only a SL data channel excluding the SA information may be transmitted from the resource pool that is configured for the SL data channel. In other words, REs that were used for transmitting SA information within a separate resource unit of the SA resource pool may still be used for transmitting SL data from the resource pool of a SL data channel.

(3) A discovery channel may be a resource pool that is used by the transmitting UE for transmitting information, such as its own ID. By doing so, the transmitting UE may allow a neighboring UE to discover the transmitting UE.

Even if the content of the above-described SL signal is the same, different resource pools may be used depending upon the transmission/reception attribute of the SL signal. For example, even if the same SL data channel or discovery message is used, the resource pool may be identified as a different resource pool depending upon a transmission timing decision method (e.g., whether the transmission is performed at a reception point of the synchronization reference signal or whether transmission is performed at the reception point by applying a consistent timing advance), a resource allocation method (e.g., whether the base station designates a transmission resource of a separate signal to a separate transmitting UE or whether a separate transmitting UE selects a separate signal transmission resource on its own from the resource pool), and a signal format (e.g., a number of symbols occupied by each SL signal within a subframe or a number of subframes being used for the transmission of one SL signal) of the SL signal, signal intensity from the base station, a transmitting power intensity (or level) of a SL UE, and so on.

Hereinafter, resource allocation in a SL will be described.

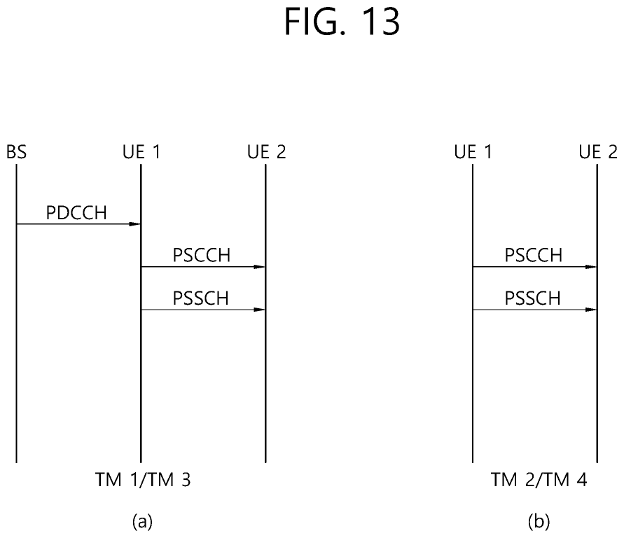

FIG. 13 shows procedures of a UE performing V2X or SL communication according to a transmission mode (TM), in accordance with an embodiment of the present disclosure. Specifically, (a) of FIG. 13 shows a UE operation related to a transmission mode 1 or a transmission mode 3, and (b) of FIG. 13 shows a UE operation related to a transmission mode 2 or a transmission mode 4.

Referring to (a) of FIG. 13, in transmission modes 1/3, the base station performs resource scheduling to UE1 via PDCCH (more specifically, Downlink Control Information (DCI)), and UE1 performs SL/V2X communication with UE2 according to the corresponding resource scheduling. After transmitting sidelink control information (SCI) to UE2 via physical sidelink control channel (PSCCH), UE1 may transmit data based on the SCI via physical sidelink shared channel (PSSCH). In case of an LTE SL, transmission mode 1 may be applied to a general SL communication, and transmission mode 3 may be applied to a V2X SL communication.

Referring to (b) of FIG. 13, in transmission modes 2/4, the UE may schedule resources on its own. More specifically, in case of LTE SL, transmission mode 2 may be applied to a general SL communication, and the UE may select a resource from a predetermined resource pool on its own and may then perform SL operations. Transmission mode 4 may be applied to a V2X SL communication, and the UE may carry out a sensing/SA decoding procedure, and so on, and select a resource within a selection window on its own and may then perform V2X SL operations. After transmitting the SCI to UE2 via PSCCH, UE1 may transmit SCI-based data via PSSCH. Hereinafter, the transmission mode may be abbreviated to the term mode.

In case of NR SL, at least two types of SL resource allocation modes may be defined. In case of mode 1, the base station may schedule SL resources that are to be used for SL transmission. In case of mode 2, the user equipment (UE) may determine a SL transmission resource from SL resources that are configured by the base station/network or predetermined SL resources. The configured SL resources or the pre-determined SL resources may be a resource pool. For example, in case of mode 2, the UE may autonomously select a SL resource for transmission. For example, in case of mode 2, the UE may assist (or help) SL resource selection of another UE. For example, in case of mode 2, the UE may be configured with an NR configured grant for SL transmission. For example, in case of mode 2, the UE may schedule SL transmission of another UE. And, mode 2 may at least support reservation of SL resources for blind retransmission.

Procedures related to sensing and resource (re-)selection may be supported in resource allocation mode 2. The sensing procedure may be defined as a process decoding the SCI from another UE and/or SL measurement. The decoding of the SCI in the sensing procedure may at least provide information on a SL resource that is being indicated by a UE transmitting the SCI. When the corresponding SCI is decoded, the sensing procedure may use L1 SL Reference Signal Received Power (RSRP) measurement, which is based on SL Demodulation Reference Signal (DMRS). The resource (re-)selection procedure may use a result of the sensing procedure in order to determine the resource for the SL transmission.

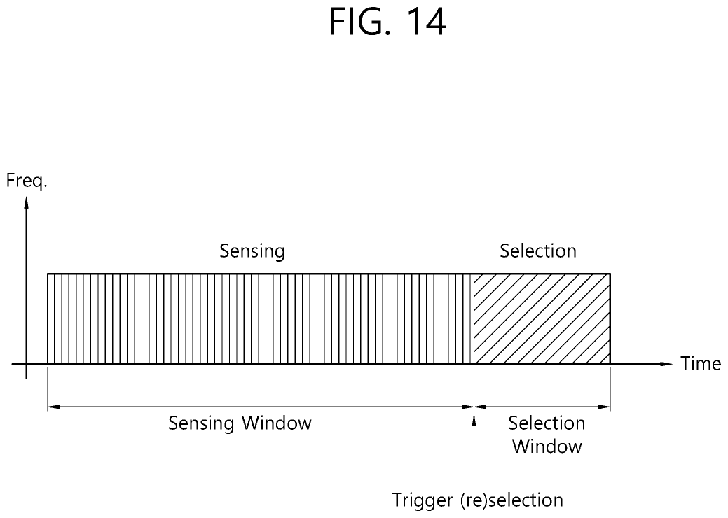

FIG. 14 shows a method of selecting a transmission resource by a UE, in accordance with an embodiment of the present disclosure.

Referring to FIG. 14, the UE may identify transmission resources reserved by another UE or resources being used by another UE via sensing within a sensing window, and, after excluding the identified resources from a selection window, the UE may randomly select a resource from resources having low interference among the remaining resources.

For example, within the sensing window, the UE may decode the PSCCH including information on the cycles of the reserved resources, and, then, the UE may measure a PSSCH RSRP from resources that are periodically determined based on the PSCCH. The UE may exclude resources having the PSSCH RSRP that exceeds a threshold value from the selection window. Thereafter, the UE may randomly select a SL resource from the remaining resources within the selection window.

Alternatively, the UE may measure a Received Signal Strength Indicator (RSSI) of the periodic resources within the sensing window and may then determine the resources having low interference (e.g., the lower 20% of the resources). Additionally, the UE may also randomly select a SL resource from the resources included in the selection window among the periodic resources. For example, in case the UE fails to perform decoding of the PSCCH, the UE may use the above described methods.

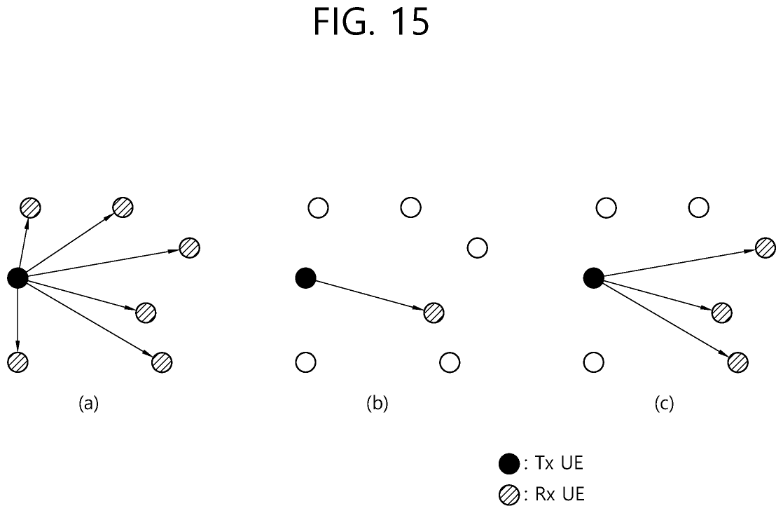

FIG. 15 shows three different cast types, in accordance with an embodiment of the present disclosure.

More specifically, (a) of FIG. 15 shows a broadcast type SL communication, (b) of FIG. 15 shows a unicast type SL communication, and (c) of FIG. 15 shows a groupcast type SL communication. In case of the broadcast type SL communication, the UE may perform one-to-one communication with another UE. And, in case of the unicast type SL communication, the UE may perform SL communication with one or more other UEs within the group to which the corresponding UE belongs. In the various embodiments of the present disclosure, the SL groupcast communication may be replaced with SL multicast communication, SL one-to-many communication, and so on.

Hereinafter, a Hybrid Automatic Repeat Request (HARQ) procedure in an SL will be described in detail.

In case of SL unicast and SL groupcast, HARQ feedback and HARQ combining in a physical layer may be supported. For example, in case a receiving UE operates in a Resource Allocation Mode 1 or 2, the receiving UE may receive a PSSCH from a transmitting UE, and the receiving UE may transmit an HARQ feedback corresponding to the PSSCH to the transmitting UE by using a Sidelink Feedback Control Information (SFCI) format via Physical Sidelink Feedback Channel (PSFCH).

For example, an SL HARQ feedback may be enabled for the unicast. In this case, in a non-Code Block Group (non-CBG), the receiving UE may decode a PSCCH targeting the receiving UE, and, when the receiving UE successfully decodes a transport block associated with the PSCCH, the receiving UE may generate an HARQ-ACK. Thereafter, the receiving UE may transmit the HARQ-ACK to the transmitting UE. Conversely, after the receiving UE decodes the PSCCH targeting the receiving UE, if the receiving UE fails to successfully decode a transport block associated with the PSCCH, the receiving UE may generate an HARQ-NACK, and the receiving UE may transmit the HARQ-NACK to the transmitting UE.

For example, an SL HARQ feedback may be enabled for the groupcast. For example, during the non-CBG, two different types of HARQ feedback options may be supported for the groupcast.

(1) Groupcast option 1: After decoding a PSCCH targeting the receiving UE, if the receiving UE fails to decode a transport block associated with the PSCCH, the receiving UE may transmit an HARQ-NACK to a transmitting UE via a PSFCH. Conversely, when a receiving UE decodes a PSCCH targeting the receiving UE, and when the receiving UE successfully decodes a transport block associated with the PSCCH, the receiving UE may not transmit an HARQ-ACK to a transmitting UE.

(2) Groupcast option 2: After decoding a PSCCH targeting the receiving UE, if the receiving UE fails to decode a transport block associated with the PSCCH, the receiving UE may transmit an HARQ-NACK to a transmitting UE via a PSFCH. And, when the receiving UE decodes a PSCCH targeting the receiving UE, and when the receiving UE successfully decodes a transport block associated with the PSCCH, the receiving UE may transmit an HARQ-ACK to a transmitting UE via the PSFCH.

According to various embodiments of the present disclosure, feedback-based retransmission may be the first device (100) performing retransmission of the first information based on feedback information received from the second device (200). For example, the blind retransmission may be the first device (100) performing retransmission to the second device (200) by reducing a code rate compared with that in the previous transmission. For example, when a delay margin is a threshold value or greater, the first device (100) may perform the retransmission to the second device (200) by reducing a redundancy rate, and when the delay margin is the threshold value or less, the first device (100) may perform the retransmission to the second device (200) by increasing the redundancy rate. For example, the blind retransmission may be retransmission of a coded packet to the second device (200) by the first device (100).

In various embodiments of the present disclosure, the information may include at least one of an SL packet, SL data, an SL message, an SL service, SL transport block (TB), SL control information, an SL data channel, and/or an SL control channel. For example, in various embodiments of the present disclosure, the information may include at least one of a UL packet, UL data, a UL message, a UL service, UL transport block (TB), UL control information, a UL data channel, and/or a UL control channel. For example, in various embodiments of the present disclosure, the information may include at least one of a DL packet, DL data, a DL message, a DL service, DL transport block (TB), DL control information, a DL data channel, and/or a DL control channel. For example, in various embodiments of the present disclosure, the latency requirement for the information may include a packet delay budget (PDB).

In various embodiments of the present disclosure, ProSe Per-Packet Priority (PPPP) may be replaced with ProSe Per-Packet Reliability (PPPR), and PPPR may be replaced with PPPP. For example, a smaller PPPP value may indicate a higher priority, and a greater PPPP value may indicate a lower priority. For example, a smaller PPPR value may indicate higher reliability, and a greater PPPR value may indicate lower reliability. For example, a PPPP value related to a service, a packet, or a message related to a high priority may be smaller than a PPPP value related to a service, a packet, or a message related to a lower priority. For example, a PPPR value related to a service, a packet, or a message related to high reliability may be smaller than a PPPR value related to a service, a packet, or a message related to low reliability.

In general, in order to secure reliability of information transmitted by the first device (100) to the second device on an unreliable channel, the first device (100) may receive whether the transmission of the information is successful (e.g., feedback) from the second device. If the transmission of the information is failed, the first device (100) may retransmit the information to the second device. However, for example, according to the feedback-based retransmission method, it may be uncertain whether the first device (100) can secure a retransmission opportunity. In addition, for example, according to the feedback-based retransmission method, if it is unclear whether or not the retransmission by the first device (100) is successful, problems of exceeding the QoS requirements of the information (e.g., allowable latency time) may occur.

Meanwhile, in order to increase the probability of successful transmission of information, the first device (100) may transmit the same information using a plurality of frequencies. For example, according to the method in which the first device (100) performs transmission using a plurality of frequencies, problems occurring in the feedback-based retransmission method may be alleviated by performing redundant transmission using a plurality of frequencies by the first device (100). However, if the first device (100) transmits the same information using a plurality of frequencies, problems of wasting transmission resources may occur.

Accordingly, according to various embodiments of the present disclosure, by considering of the latency requirement of information to be transmitted by the first device (100), a method of transmitting the information based on different transmission methods according to time and an apparatus supporting the same are proposed.

In various embodiments of the present disclosure, a current time point may be referred to as t. A (virtual) transmission delay deadline for information to be transmitted included in a transmission buffer of the first device (100) may be referred to as t_{d}. For example, an actual transmission delay deadline for the information to be transmitted by the first device (100) may be the same as t_{d}. For example, the actual transmission delay deadline for the information to be transmitted by the first device (100) may be a time point corresponding to t_{d} plus a specific margin value (T_{M}). For example, the actual transmission delay deadline for the information to be transmitted by the first device (100) may be referred to as tₘₐₓ.

In various embodiments of the present disclosure, the first device (100) may determine a frequency to be used for transmission of information and/or the number of frequencies to be used for transmission of information. For example, the frequency to be used for transmission of information and/or the number of frequencies to be used for transmission of information may be determined by the L2 layer of the first device (100). For example, the L2 layer may include at least one of a PDCP layer, an RLC layer, and/or a MAC layer. For example, the L2 layer may include a PHY layer. For example, the L2 layer may receive information to be transmitted from an upper layer, and the L2 layer may transmit the information. Here, for example, the information may be a packet or a packet data unit. For example, the information may be at least one of a PDCP PDU, an RLC PDU, and/or a MAC SDU. For example, the L2 layer may store information to be transmitted in a transmission buffer. Here, the transmission buffer may be a transmission buffer used to transmit the information using a specific interface. For example, the transmission buffer may be used to transmit SL information. For example, the transmission buffer may be used to transmit UL information. For example, the transmission buffer may be used to transmit DL information.

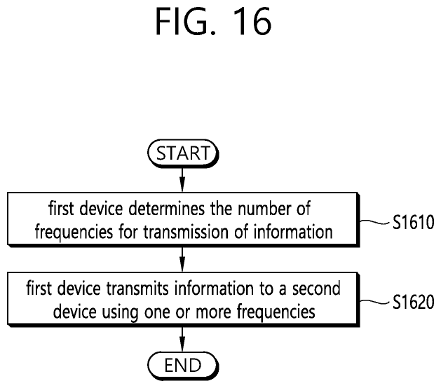

FIG. 16 shows a method in which the first device (100) transmits information using one or more frequencies, in accordance with an embodiment of the present disclosure. The embodiment of FIG. 16 may be combined with various embodiments of the present disclosure.

Referring to FIG. 16, in step S1610, the first device (100) may determine at least one frequency and/or the number of frequencies for transmission of information. For example, the first device (100) may determine at least one frequency and/or the number of frequencies for transmission of information based on latency requirement of the information.

In step S1620, the first device (100) may transmit the information to the second device (200) using the determined at least one frequency.

In various embodiments of the present disclosure, a remaining time from a time point at which the first device (100) transmits information to a transmission delay deadline for the information may be referred to as T_{R}, an allowed transmission time or an allowed delay time. For example, a remaining time from a time point at which the first device (100) determines to transmit the information to the transmission delay deadline for the information may be referred to as T_{R}, the allowed transmission time or the allowed delay time. For example, the allowed transmission time or the allowed delay time at time t may be represented as T_{R}(t). For example, the first device (100) may change the number of frequencies to be used according to the T_{R}. For example, the first device (100) may determine the number of frequencies for transmission of information according to the allowed transmission time, and may transmit the information to the second device (200) using one or more frequencies.

For example, if the allowed transmission time of information is sufficiently long, the first device (100) may transmit the information to the second device (200) using a small number of frequencies. For example, if the allowed transmission time of information is greater than or equal to a threshold value, the first device (100) may transmit the information to the second device (200) using a relatively small number of frequencies. For example, in case that the allowed transmission time related to information is sufficiently long, even if the first device (100) transmits the information to the second device (200) using a small number of frequencies, the first device (100) may have an opportunity to retransmit the information to the second device (200). Therefore, the first device (100) has a high possibility of successfully transmitting information within the allowed transmission time. In this case, if the first device (100) transmits information using a large number of frequencies, the channel usage rate may be unnecessarily increased, and unnecessary interference may be caused to other UEs. For example, if T_{R}(t)>a threshold value, the first device (100) may transmit the information to the second device (200) using one frequency. For example, if T_{R}(t)≥a threshold value, the first device (100) may transmit the information to the second device (200) using one frequency.

For example, if the allowed transmission time of information is not sufficient, the first device (100) may transmit the information to the second device (200) using a large number of frequencies. For example, if the allowed transmission time of information is less than or equal to a threshold value, the first device (100) may transmit the information to the second device (200) using a relatively large number of frequencies. For example, if the allowed transmission time is less than or equal to a threshold value, and if a probability that the first device (100) can successfully transmit information within the allowed transmission time is low, the first device (100) may transmit the information using more frequencies. For example, the first device (100) may perform redundant transmission for the information. Accordingly, the probability that the information is successfully transmitted within the allowed transmission time may increase. For example, if T_{R}(t)<a threshold value, the first device (100) may transmit the information to the second device (200) using a plurality of frequencies (e.g., two frequencies). For example, if T_{R}(t)≤a threshold value, the first device (100) may transmit the information to the second device (200) using a plurality of frequencies (e.g., two frequencies). For example, the first device (100) may transmit N pieces of identical information to the second device (200) using N frequencies. Here, N may be an integer of 2 or more.

Specifically, for example, the first device (100) may determine transmission of information at time point t. For example, transmission of information may be determined by the L2 layer of the first device (100). For example, the first device (100) may transmit information to the second device (200) at time point t.

For example, the transmission may be an initial transmission or a new transmission of the first device (100). For example, the transmission may be the first transmission of a PDU transferred from an upper layer to the L2 layer. For example, the transmission may be a retransmission of the first device (100). For example, the transmission may be transmission after the first transmission of the PDU transferred from the upper layer to the L2 layer.

For example, it is assumed that a time point at which the first device (100) can actually transmit information in a buffer to the second device (200) wirelessly is t+T1. Further, it is assumed that a time point at which the first device (100) receives feedback on whether the information is successfully received from the second device (200) receiving the information is t+T1+T2. In addition, it is assumed that a time point at which the first device (100) can wirelessly retransmit the information to the second device (200) after determining retransmission based on the feedback (e.g., NACK feedback) received from the second device (200) is t+T1+T2+T3. It is assumed that T1+T2+T3 is Tₛᵤₘ. For example, if the first device (100) wirelessly transmits information currently in the transmission buffer to the second device (200), receives feedback on whether transmission of the information is successful from the second device (200), determines to retransmit the information based on the feedback, and wirelessly retransmits the information to the second device (200), Tₛᵤₘ may be time taken from a time point at which the first device (100) determines to transmit the information currently in the transmission buffer to a time point at which the first device (100) retransmits the information.

If at least one of T1, T2, and/or T3 is a value that is not constant but variable, the first device (100) may calculate Tₛᵤₘ using an average value each of T1, T2, and/or T3 or average value+margin. If the first device (100) knows the probability distribution of Tᵢ (e.g., i is 1, 2, or 3), the first device (100) may calculate Tₛᵤₘ, considering/determining that T_{thres_i} satisfying P (Tᵢ<T_{thres_i})=Pₜₕᵣₑₛ as Tᵢ. P (X<Y) may be a probability value that Y exceeds X.

For example, assuming that the current time point is t, the first device (100) may determine the number of frequencies for transmission of information according to t+M*Tₛᵤₘ and tₘₐₓ. For example, the first device (100) may determine the number of frequencies for transmission of information according to whether or not T+M*Tₛᵤₘ is less than tₘₐₓ. For example, if t+M*Tₛᵤₘ is less than or equal to tₘₐₓ, the first device (100) may transmit information to the second device (200) using A frequencies. For example, if T_{R}(t) is greater than or equal to a threshold value, the first device (100) may transmit information to the second device (200) using A frequencies. For example, if t+M*Tₛᵤₘ is greater than or equal to tₘₐₓ, the first device (100) may transmit information to the second device (200) using B frequencies. For example, if T_{R}(t) is less than or equal to a threshold value, the first device (100) may transmit information to the second device (200) using B frequencies. Here, B may be an integer greater than A.

For example, M may be a value configured/defined in advance for the first device (100). For example, a network and/or another device may configure or pre-configure M for the first device (100). For example, M may be the maximum (average) number of allowed retransmissions to satisfy a service-related QoS requirement. For example, M may be the minimum (average) number of allowed retransmissions to satisfy a service-related QoS requirement. For example, M may be adjusted/determined according to at least one of the priority of traffic, a QoS requirement, and/or a congestion level. For example, the QoS requirement may include a delay budget and/or transmission reliability. For example, the congestion level may include CBR. For example, a relatively great value of M may be applied to traffic having a relatively high priority. For example, a relatively great value of M may be applied to traffic having a strict QoS requirement.

1) First Case: For example, if t+M*Tₛᵤₘ<tₘₐₓ, the first device (100) may transmit information to the second device (200) using A frequencies. For example, the A value may be set to 1. For example, transmitting information using A frequencies by the first device (100) may include transmitting the same information using A frequencies by the first device (100).

For example, in order to transmit the same information using a plurality of frequencies, the first device (100) may duplicate the same packet in the PDCP layer and may transmit it based on A bearers. For example, the bearer may be at least one of a SL bearer, a UL bearer, and/or a DL bearer. For example, the first device (100) may allocate the same logical channel priority to each logical channel related to A bearers, and the first device (100) may not perform multiplexing for the A logical channels in the MAC layer. Accordingly, the first device (100) may transmit a packet of each logical channel based on an individual TB or MAC PDU. As another example, each of the duplicated packets may be transferred to different MAC entities, and each of the different MAC entities of the first device (100) may perform transmission using different carriers/cells.

For example, in order to transmit the same information using a plurality of frequencies, the first device (100) may duplicate the same packet in the MAC layer to generate A transport blocks (TBs) (or A MAC PDUs), and the first device (100) may transmit each of the TBs (or the MAC PDUs) through associated frequencies.

For example, in case that the first device (100) transmits the same information based on a plurality of frequencies, the first device (100) may transmit the same information using each frequency based on dynamic scheduling. Alternatively, for example, the first device (100) may transmit the same information based on static scheduling. For example, in the case of transmission based on the static scheduling, the first device (100) may transmit the same information by using pre-allocated resources through semi-persistent scheduling or configured grant.

For example, in case that the first device (100) transmits information using A frequencies, it may be desirable to prevent the transmission power from being distributed to each frequency by not overlapping the transmission of each frequency in time. However, with respect to the first device (100) that transmits information, if transmission opportunity of the information is insufficient before the allowed transmission time of the information, the first device (100) may transmit information using all or part of A frequencies simultaneously. This may be referred to as concurrent multi-carrier transmission.

For example, if T+M*Tₛᵤₘ<tₘₐₓ, the first device (100) may transmit information in the buffer to the second device (200) on each frequency belonging to A frequencies, and the first device (100) may receive at least one feedback for the information transmitted on each frequency from the second device (200). In addition, the first device (100) may determine whether or not to retransmit the information to the second device (200) on the corresponding frequency based on the feedback.

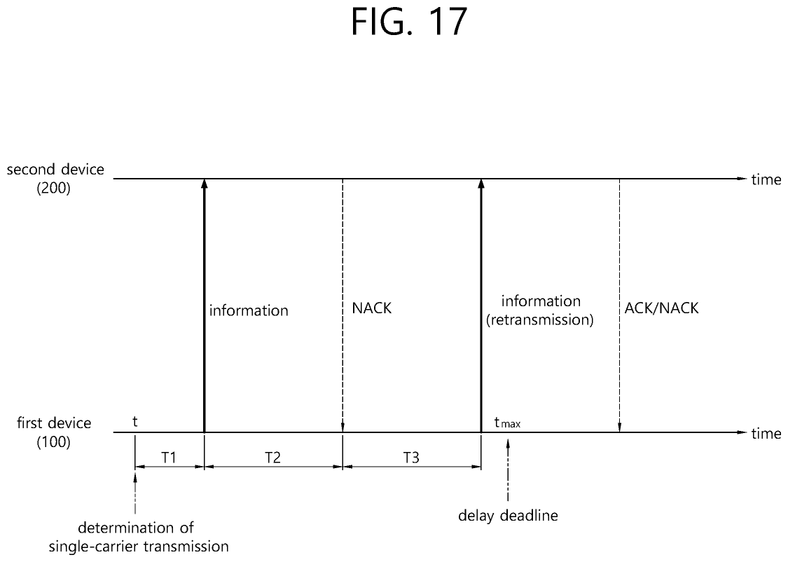

FIG. 17 shows a method in which the first device (100) transmits information using one frequency, in accordance with an embodiment of the present disclosure. In the embodiment of FIG. 17, it is assumed that M is 1.

Referring to FIG. 17, the first device (100) may evaluate/determine a value oft+T1+T2+T3 and a value of tₘₐₓ at a time point t. In the embodiment of FIG. 17, since t+T1+T2+T3<tₘₐₓ, the first device (100) may determine to transmit a packet using one frequency.

For example, the case of M=1 (i.e., t+Tₛᵤₘ<tₘₐₓ) may be a case where the time point at which retransmission information is wirelessly transmitted is before tₘₐₓ even if the first device (100) that is failed to transmit information performs retransmission based on the feedback from the second device (200). In general, if the first device (100) receives a NACK feedback from the second device (200), the first device (100) may determine retransmission to the second device (200). In case of the HARQ retransmission, if the first device (100) receives HARQ NACK for the information transmitted by the first device (100), the first device (100) may perform retransmission.

2) Second Case: For example, if t+M·Tₛᵤₘ≥tₘₐₓ, the first device (100) may transmit information to the second device (200) using B frequencies. For example, B may be an integer greater than A. Thus, for example, if A is 1, B may be an integer of 2 or more.

For example, B frequencies may include A frequencies and additional frequencies. For example, in case that A frequencies consist of {F1, F2}, B frequencies may consist of {F1, F2, . . . , Fx}. For example, B frequencies may include some of A frequencies and additional frequencies. For example, in case that A frequencies consist of {F1, F2}, B frequencies may consist of {F2, . . . , Fy}. For example, B frequencies may include only other frequencies not included in A frequencies. For example, in case that A frequencies consist of {F1, F2}, B frequencies may consist of {F3, . . . , Fz}.

For example, transmitting information by the first device (100) using B frequencies may include transmitting the same information by the first device (100) using B frequencies.

For example, in order to transmit the same information using a plurality of frequencies, the first device (100) may duplicate the same packet in the PDCP layer and may transmit it based on B bearers. For example, the bearer may be at least one of a SL bearer, a UL bearer, and/or a DL bearer. For example, the first device (100) may allocate the same logical channel priority to each logical channel related to B bearers, and the first device (100) may not perform multiplexing for the B logical channels in the MAC layer. Accordingly, the first device (100) may transmit a packet of each logical channel based on an individual TB or MAC PDU.

For example, in order to transmit the same information using a plurality of frequencies, the first device (100) may duplicate the same packet in the MAC layer to generate B transport blocks (TBs) (or B MAC PDUs), and the first device (100) may transmit each of the TBs (or the MAC PDUs) through associated frequencies.

For example, in case that the first device (100) transmits information using B frequencies, it may be desirable to prevent the transmission power from being distributed to each frequency by not overlapping the transmission of each frequency in time. However, with respect to the first device (100) that transmits information, if transmission opportunity of the information is insufficient before the allowed transmission time of the information, the first device (100) may transmit information using all or part of B frequencies simultaneously. This may be referred to as concurrent multi-carrier transmission.

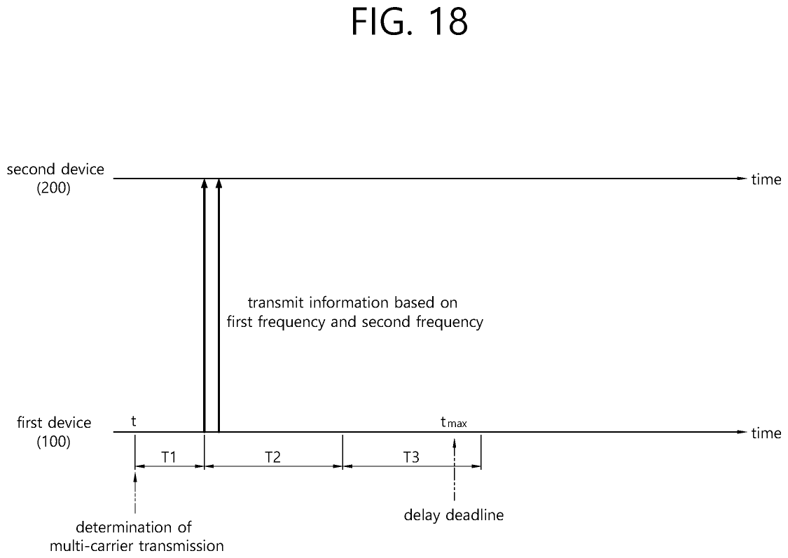

FIG. 18 shows a method in which the first device (100) transmits information using two frequencies, in accordance with an embodiment of the present disclosure. In the embodiment of FIG. 18, it is assumed that M is 1.

Referring to FIG. 18, the first device (100) may evaluate/determine a value of t+T1+T2+T3 and a value of tₘₐₓ at a time point t. In the embodiment of FIG. 18, since t+T1+T2+T3>tₘₐₓ, the first device (100) may determine to transmit a packet using two frequencies.

For example, it may be considered to vary the value of B according to the QoS requirements of the information to be transmitted by the first device (100). For example, the first device (100) may apply a higher B value to information having a high QoS requirement. For example, comparing with information having a low QoS requirement, the first device (100) may transmit information having a high QoS requirement to the second device (200) by using a large number of frequencies.

For example, the first device (100) may apply the second case only when information having a QoS requirement higher than a threshold value is transmitted. Otherwise, the first device (100) may apply the first case. For example, the first device (100) may apply the first case for the transmission of information basically, and the first device (100) may allow the second case for the transmission of information having a reliability requirement equal to or greater than a threshold value.

For example, the B value may be pre-configured for the first device (100). For example, the base station may configure the B value to the first device (100) through RRC signaling. For example, a server that manages configuration for the first device (100) may configure the B value to the first device (100) by using provision through a method such as open mobile alliance (OMA) device management (DM), and so on.

For example, frequency configuration for B frequencies may be pre-configured for the first device (100). For example, the base station may configure the frequency configuration for B frequencies to the first device (100) through RRC signaling. For example, a server that manages configuration for the first device (100) may configure the frequency configuration for B frequencies to the first device (100) by using provision through a method such as open mobile alliance (OMA) device management (DM), and so on.

For example, the case of M=1 (i.e., t+Tₛᵤₘ≥tₘₐₓ) may be a case where the feedback-based retransmission opportunity for transmission of the information does not exist before tₘₐₓ. According to an embodiment of the present disclosure, in this case, even if the first device (100) fails to transmit information through one frequency, the first device (100) may succeed in transmitting information through another frequency. Accordingly, the first device (100) may successfully transmit the information to the second device (200) before the deadline of information transmission. That is, the probability that the first device (100) successfully transmits information before the deadline of the information transmission may increase.

Meanwhile, in case that the second case is satisfied (i.e., t+M·Tₛᵤₘ≥tₘₐₓ), it is necessary for the first device (100) transmitting information using B frequencies to determine how to perform retransmission on each frequency.

For example, according to the first method, for transmission on each frequency, the first device (100) may perform retransmission to the second device (200) without waiting for the feedback from the second device (200). That is, the first device (100) may perform data transmission of a buffer, and may perform retransmission (e.g., blind retransmission) without receiving the feedback for transmission. In order to minimize unnecessary retransmission, the first device (100) performs blind retransmission, only when there is a high probability of exceeding the allowed delay time in case of performing retransmission after receiving feedback on each frequency. For example, if M is 1, the first device (100) may apply the first method.

For example, according to the second method, in the case of t+M·Tₛᵤₘ≥tₘₐₓ, if it is necessary for the first device (100) to perform retransmission after waiting for the feedback for transmission on each frequency, only when the first device (100) receives NACK information from the second device (200), the first device (100) may perform retransmission. For example, in case that there is an opportunity for the first device (100) to perform retransmission after receiving feedback on each frequency before the allowed transmission time, the first device (100) may perform retransmission according to the second method. For example, if M is greater than 1, the first device (100) may apply the second method.

For example, the first device (100) may perform blind retransmission once with respect to initial transmission. For example, in order to increase the probability of successful reception by the second device (200), the first device (100) may perform blind retransmission a plurality of times with respect to the initial transmission.

For example, the first device (100) may determine the number of blind retransmissions according to reliability requirements of information to be transmitted. For example, if the first device (100) performs blind retransmission of R times, the R value is determined based on the reliability requirements or congestion level (e.g., CBR) of the information to be transmitted by the first device (100). For example, in the case of information having a relatively high reliability requirement, the first device (100) may apply/determine a relatively large R value for blind retransmission. For example, the R value may be the maximum number of allowed blind retransmissions (in an average aspect) to satisfy service-related QoS requirements. For example, the R value may be the minimum number of allowed blind retransmissions (in an average aspect) to satisfy service-related QoS requirements. For example, if the first device (100) does not support all blind retransmissions of R times within tₘₐₓ, the first device (100) may perform only blind retransmissions as many times as possible within tₘₐₓ. For example, if the first device (100) does not support all blind retransmissions of R times within tₘₐₓ, the first device (100) may omit the transmission of the corresponding information.

For example, the L2 layer (e.g., the MAC layer) of the first device (100) may indicate the PHY layer of the first device (100) to transmit and/or retransmit the information. In this case, the L2 layer of the first device (100) may transfer information to retransmit the information R times to the PHY layer of the first device (100). In case that the L2 layer of the first device (100) is configured to indicate the number of retransmissions to the PHY layer of the first device (100), if the number of retransmissions is not indicated, the first device (100) may retransmit the information once.

Specifically, for example, the L2 layer of the first device (100) may indicate the PHY layer of the first device (100) to transmit and/or retransmit information according to a method described below.

For example, the L2 layer of the first device (100) may transfer a transmission instruction and a retransmission instruction for information to the PHY layer of the first device (100) at the same timing.

For example, while the L2 layer of the first device (100) transfers a transmission instruction and a retransmission instruction for information to the PHY layer of the first device (100) at the same timing, the L2 layer of the first device (100) may also transfer Tᵣₑ value to the PHY layer of the first device (100). For example, Tᵣₑ may be the time interval between initial transmission and retransmission.

For example, the L2 layer of the first device (100) may transfer a transmission instruction for information to the PHY layer of the first device (100). In addition, after Tᵣₑ from the time when the L2 layer of the first device (100) transfers the transmission instruction for information to the PHY layer of the first device (100), the L2 layer of the first device (100) may transfer the retransmission instruction for information to the PHY layer of the first device (100). For example, the Tᵣₑ value may be determined/configured differently according to a priority of information to be transmitted by the first device (100) and/or a delay budget of information to be transmitted by the first device (100). For example, the first device (100) may apply a relatively short Tᵣₑ value to information having a relatively high priority. For example, the first device (100) may apply a relatively short Tᵣₑ value to information having a short remaining time until deadline.

For example, the first device (100) may perform initial transmission and retransmission of information on different resource regions. For example, the PHY layer of the first device (100) may perform initial transmission and retransmission of information by using different resources. The first device (100) may perform transmission and retransmission in consecutive time durations. For example, transmission and retransmission may occur on multi-subframes, multi-slots and/or multi-minislots contiguous in the time domain. For this, the first device (100) may perform (mini) slot aggregation in which transmission resources are used by concatenating in the time domain. If the Tᵣₑ value is not indicated or the Tᵣₑ value is zero, transmission and retransmission may occur in consecutive time durations. If the Tᵣₑ value is indicated and/or the Tᵣₑ value is not zero, the first device (100) may perform retransmission after a time when Tᵣₑ passes at the transmission timing (Tₜₓ), that is, at a time Tₜₓ+Tᵣₑ.

For example, the first device (100) may independently transmit transmission-related scheduling information and retransmission-related scheduling information using different control channel instances. For example, the first device may transmit the transmission-related scheduling information and the retransmission-related scheduling information through separate pieces of control information.

For example, the first device (100) may transmit the transmission-related scheduling information and one or more pieces of retransmission-related scheduling information via one control channel instance. For example, the first device (100) may transmit the transmission-related scheduling information and the one or more pieces of retransmission-related scheduling information through the same control information. For example, the control channel instance including the scheduling information may include the number of retransmissions and/or time information and/or frequency information on a radio resource for performing each retransmission. For example, when a plurality of (re)transmissions is temporally contiguous, the control channel instance may indicate a time period occupied by each (re)transmission. For example, when a frequency resource used for each retransmission is the same as a frequency resource used for the transmission, information on a frequency may not be included in the control channel instance.

For example, the first device (100) may transmit the transmission-related scheduling information and the retransmission-related scheduling information using different control channel instances. In this case, the first device (100) may transmit one or more pieces of retransmission-related scheduling information via one control channel instance. For example, the control channel instance including the retransmission-related scheduling information may include at least one of the number of retransmissions, time information and/or frequency information on a radio resource for performing each retransmission, and/or information necessary for decoding. For example, the information necessary for decoding may include a modulation and channel coding scheme/coding rate, a redundancy version, and the like. For example, when a plurality of retransmissions is temporally contiguous, the control channel instance for retransmission-related scheduling may indicate the duration of a resource occupied by each (re)transmission. For example, when the duration of a resource used for first retransmission and the duration of a resource used for subsequent retransmission are the same, information indicating the duration of the resource for the subsequent retransmission may be omitted. For example, when a frequency resource for the first retransmission and a frequency resource for the subsequent retransmission indicated by the control channel instance for retransmission-related scheduling are the same, information on the frequency resource for the subsequent retransmission may be omitted.

A resource region for blind retransmission may be separately allocated. Information on the resource region separately allocated for blind retransmission may be preset for the UE.

According to an embodiment of the present disclosure, if the first device (100) transmits information to the second device (200), and if the first device (100) fails to receive feedback for the information within an expected time to receive the feedback, the first device (100) may assume/determine that it has received a NACK feedback, and the first device (100) may perform blind retransmission. Specifically, for example, if t+Tₛᵤₘ<tₘₐₓ is satisfied, the first device (100) may transmit information to the second device (200) and wait for feedback. In this case, if the first device (100) fails to receive the feedback until the time point t+T1+T2, the first device (100) may assume/determine that it has received the NACK feedback, and the first device (100) may perform blind retransmission. For example, the first device (100) may perform retransmission of the information once according to various embodiments of the present disclosure. For example, the first device (100) may perform retransmission of the information multiple times according to various embodiments of the present disclosure.

According to an embodiment of the present disclosure, the first device (100) may apply various implementations of the present disclosure according to a priority of the information or the QoS requirement of the information to be transmitted by the first device (100), selectively or differentially.

For example, the first device (100) may selectively apply various implementations of the present disclosure. For example, if the QoS requirement level of the information to be transmitted by the first device (100) is greater than a certain level, for example, if the QoS requirement level of the information to be transmitted by the first device (100) is equal to or greater than a pre-configured threshold, the first device (100) may transmit the information according to the second case. For example, if a priority of the information to be transmitted by the first device (100) or a priority of a logical channel to which the information is transmitted is greater than or equal to a certain priority, the first device (100) may transmit the information according to the second case. In the sidelink, for example, if PPPP of information to be transmitted by the first device (100) is less than a threshold value, the first device (100) may transmit the information according to the second case. For example, if the QoS requirement level of the information to be transmitted by the first device (100) is less than or equal to a certain level, even if t+M·Tₛᵤₘ≥tₘₐₓ is satisfied, the first device (100) may transmit the information to the second device (200) using one frequency.

For example, the first device (100) may differentially apply various implementations of the present disclosure. For example, after sorting the QoS requirement level of information or the priority of information in order, it can be divided into several sections. Here, for example, for a group having a relatively high QoS requirement level or a group having a relatively high priority of information, the first device (100) may preferentially transmit the information according to the second case. For this, according to the QoS requirement level or the priority of information of the corresponding group, the first device (100) may adjust a T_{M} value (e.g., a margin between a virtual delay deadline and an actual delay deadline) and/or an R value applied to information transmission of a corresponding group. For example, for a group having a high QoS requirement level or a high priority, the first device (100) may apply a large T_{M} value and/or a large R value.

Meanwhile, various embodiments of the present disclosure may also be applied when a deadline for a packet approaches while the first device (100) performs an operation (e.g., a listen-before-talk (LBT) operation) of determining whether a shared channel is idle in order to secure an opportunity to use the channel. For example, it is assumed that the first device (100) has obtained an opportunity to transmit information at a time point of T through an LBT operation. Here, it is assumed that a deadline for information is Td. In this case, various embodiments as follows may be considered.

1) First method: For example, when Td−T is less than a threshold value, the first device (100) may perform transmission and blind retransmission. For example, when Td−T is greater than the threshold value, the first device (100) may perform only the transmission. For example, when the transmission is transmission requiring feedback, the first device (100) may wait for feedback after performing the transmission and may determine whether to perform retransmission according to the feedback.

2) Second method: For example, when Td−T is less than a threshold value, the first device (100) may perform transmission and blind retransmission. For example, as Td−T increases, the first device (100) may increase the number of blind retransmissions. In another example, as Td−T decreases, the first device (100) may increase the number of blind retransmissions.

According to various embodiments of the present disclosure, in consideration of a latency requirement of information (e.g., a packet delay budget (PDB) of a packet) to be transmitted by the first device (100), the first device (100) may change transmission method of the information according to time. For example, in consideration of a deadline at which the first device (100) should transmit information, the first device (100) may configure or determine the number of frequencies used for information transmission differently. For example, as the remaining time until the delay deadline of information becomes shorter, the first device (100) may increase the number of frequencies to be used for transmission. Accordingly, only when the first device (100), which is performing an operation of minimizing resource waste by performing feedback-based retransmission as much as possible, determines that a probability of not satisfying the QoS requirement of the packet becomes increases, the first device (100) may perform redundant transmission using more frequencies. Therefore, according to various embodiments of the present disclosure, resource waste may be minimized, and QoS requirements of information to be transmitted by the first device (100) may be maximally satisfied.

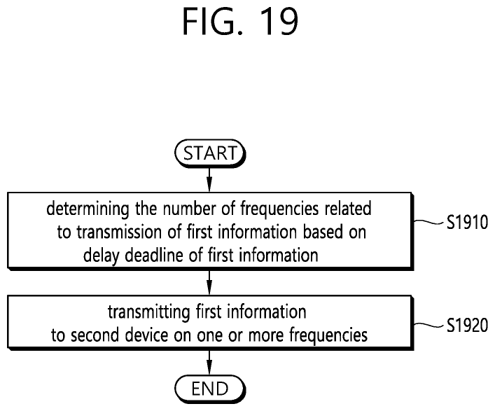

FIG. 19 shows a method in which the first device (100) performs transmission using one or more frequencies, in accordance with an embodiment of the present disclosure. The embodiment of FIG. 19 may be combined with various embodiments of the present disclosure.

Referring to FIG. 19, in step S1910, the first device (100) may determine a number of frequencies related to transmission of first information based on a delay deadline of the first information. For example, the first information may be sidelink information, uplink information, or downlink information. For example, a QoS requirement or a reliability requirement of the first information may be greater than a threshold value.

In step S1920, the first device (100) may transmit the first information to a second device (200) on one or more frequencies.

Additionally, the first device (100) may determine a first difference value between the delay deadline and a time point at which transmission of the first information is determined. For example, the first information may be transmitted on one frequency based on the first difference value greater than or equal to a threshold value. For example, the first information may be transmitted on a plurality of frequencies based on the first difference value less than or equal to a threshold value.

Additionally, the first device (100) may determine a second difference value between a time point at which transmission of the first information is determined and a time point at which retransmission of the first information is performed based on feedback from the second device. For example, the first information may be transmitted on one frequency based on the second difference value that is less than the first difference value. For example, the first information may be transmitted on a plurality of frequencies based on the second difference value that is greater than or equal to the first difference value. For example, the first information transmitted on each of the plurality of frequencies may be the same information.

Additionally, the first device (100) may determine a third difference value between the delay deadline and a time point at which the first information is transmitted. For example, the first information may be transmitted on one frequency based on the third difference value greater than or equal to a threshold value. For example, the first information may be transmitted on a plurality of frequencies based on the third difference value less than or equal to a threshold value.

Additionally, the first device (100) may determine a fourth difference value between a time point to which the first information is transmitted and a time point at which retransmission of the first information is performed based on feedback from the second device. For example, the first information may be transmitted on one frequency based on the fourth difference value that is less than the third difference value. For example, the first information may be transmitted on a plurality of frequencies based on the fourth difference value that is greater than or equal to the third difference value. For example, the first information transmitted on each of the plurality of frequencies may be the same information.

For example, the number of frequencies related to transmission of the first information may be determined based on a QoS requirement or a reliability requirement of the first information. For example, a number of frequencies related to transmission of information having low QoS requirement or low reliability requirement may be less than a number of frequencies related to transmission of information having high QoS requirement or high reliability requirement.

For example, the first information may be transmitted on one frequency based on a QoS requirement or a reliability requirement of the first information less than a threshold value.

For example, the first information may be transmitted on the one or more frequencies by being duplicated in L2 layer of the first device (100).

The proposed method may be performed by an apparatus according to various embodiments of the present disclosure. First, the processor (102) of the first device (100) may determine a number of frequencies related to transmission of first information based on a delay deadline of the first information. In addition, the processor (102) of the first device (100) may control transceiver (106) to transmit the first information to a second device (200) on one or more frequencies.

Various embodiments of the present disclosure may be implemented independently. Alternatively, the various embodiments of the present disclosure may be combined or merged with each other. For example, although the various embodiments of the present disclosure have been described based on a 3GPP system for convenience of description, the various embodiments of the present disclosure can extend to other systems apart from the 3GPP system. For example, the various embodiments of the present disclosure are not limited to direct communication between UEs but may also be used in an uplink or downlink, in which case a base station or a relay node may use the proposed method according to various embodiments of the present disclosure. For example, some of the various embodiments of the present disclosure may be limitedly applied to resource allocation mode 1. For example, some of the various embodiments of the present disclosure may be limitedly applied only to resource allocation mode 2. For example, some of the various embodiments of the present disclosure may be limitedly applied only to preset/signaled (specific) V2X channel/signal transmission (e.g., a PSSCH and/or (linked) PSCCH and/or PSBCH). For example, some of various embodiments of the present disclosure may be limitedly applied only when a PSSCH and a (linked) PSCCH are adjacently transmitted (in the frequency domain). For example, some of the various embodiments of the present disclosure may be limitedly applied only when a PSSCH and a (linked) PSCCH are non-adjacently transmitted (in the frequency domain). For example, some of the various embodiments of the present disclosure may be limitedly applied only when transmission based on a preset/signaled MCS and/or a coding rate and/or an RB value/range is performed. For example, some of the various embodiments of the present disclosure may be (limitedly) applied only when carriers have the same (and/or (partially) different) positions and/or number of synchronization signal (transmission and/or reception) resources (and/or positions and/or number of V2X resource pool-related subframes (and/or size and/or number of subchannels)). For example, some of the various embodiments of the present disclosure may also be applied in an extended manner to (V2X) communication between a base station and a UE. For example, some of the various embodiments of the present disclosure may be limitedly applied to only at least one of unicast (sidelink) communication, groupcast (sidelink) communication, and/or broadcast (sidelink) communication.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, various fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

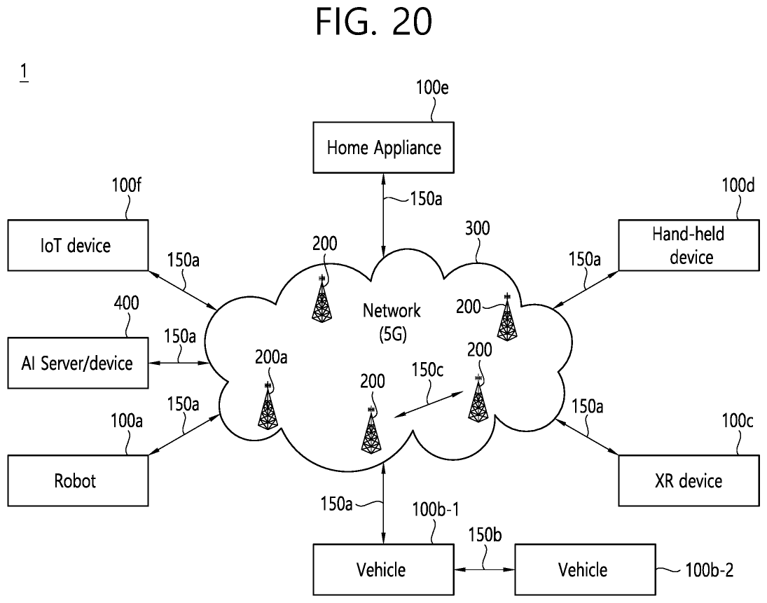

FIG. 20 shows a communication system (1) in accordance with an embodiment of the present disclosure.

Referring to FIG. 20, a communication system (1) to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot (100a), vehicles (100b-1, 100b-2), an eXtended Reality (XR) device (100c), a hand-held device (100d), a home appliance (100e), an Internet of Things (IoT) device (100f), and an Artificial Intelligence (AI) device/server (400). For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device (200a) may operate as a BS/network node with respect to other wireless devices.

The wireless devices (100a˜100f) may be connected to the network (300) via the BSs (200). An AI technology may be applied to the wireless devices (100a˜100f) and the wireless devices (100a˜100f) may be connected to the AI server (400) via the network (300). The network (300) may be configured using a 3G network, a 4G (e.g., LTE) network, or a 5G (e.g., NR) network. Although the wireless devices (100a˜100f) may communicate with each other through the BSs (200)/network (300), the wireless devices (100a˜100f) may perform direct communication (e.g., sidelink communication) with each other without passing through the BSs/network. For example, the vehicles (100b-1, 100b-2) may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices (100a˜100f).

Wireless communication/connections (150a, 150b, 150c) may be established between the wireless devices (100a˜100f)/BS (200), or BS (200)/BS (200). Herein, the wireless communication/connections may be established through various RATs (e.g., 5G NR) such as uplink/downlink communication (150a), sidelink communication (150b) (or, D2D communication), or inter BS communication (e.g. relay, Integrated Access Backhaul (IAB)). The wireless devices and the BSs/the wireless devices may transmit/receive radio signals to/from each other through the wireless communication/connections (150a, 150b). For example, the wireless communication/connections (150a, 150b) may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

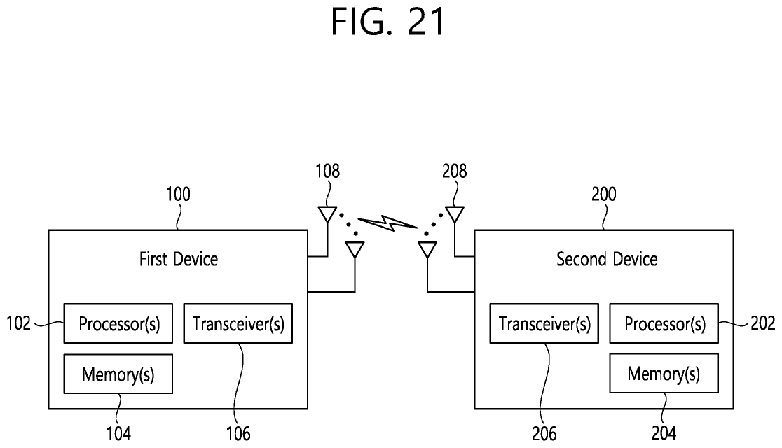

FIG. 21 shows wireless devices in accordance with an embodiment of the present disclosure.

Referring to FIG. 21, a first wireless device (100) and a second wireless device (200) may transmit radio signals through various RATs (e.g., LTE and NR). Herein, {the first wireless device (100) and the second wireless device (200)} may correspond to {the wireless device (100x) and the BS (200)} and/or {the wireless device (100x) and the wireless device (100x)} of FIG. 20.

The first wireless device (100) may include one or more processors (102) and one or more memories (104) and additionally further include one or more transceivers (106) and/or one or more antennas (108). The processor(s) (102) may control the memory(s) (104) and/or the transceiver(s) (106) and may be configured to implement the descriptions, functions, procedures, proposals, methods, and/or operational flowcharts disclosed in this document. For example, the processor(s) (102) may process information within the memory(s) (104) to generate first information/signals and then transmit radio signals including the first information/signals through the transceiver(s) (106). The processor(s) (102) may receive radio signals including second information/signals through the transceiver (106) and then store information obtained by processing the second information/signals in the memory(s) (104). The memory(s) (104) may be connected to the processor(s) (102) and may store various information related to operations of the processor(s) (102). For example, the memory(s) (104) may store software code including commands for performing a part or the entirety of processes controlled by the processor(s) (102) or for performing the descriptions, functions, procedures, proposals, methods, and/or operational flowcharts disclosed in this document. Herein, the processor(s) (102) and the memory(s) (104) may be a part of a communication modem/circuit/chip designed to implement RAT (e.g., LTE or NR). The transceiver(s) (106) may be connected to the processor(s) (102) and transmit and/or receive radio signals through one or more antennas (108). Each of the transceiver(s) (106) may include a transmitter and/or a receiver. The transceiver(s) (106) may be interchangeably used with Radio Frequency (RF) unit(s). In the present disclosure, the wireless device may represent a communication modem/circuit/chip.

The second wireless device (200) may include one or more processors (202) and one or more memories (204) and additionally further include one or more transceivers (206) and/or one or more antennas (208). The processor(s) (202) may control the memory(s) (204) and/or the transceiver(s) (206) and may be configured to implement the descriptions, functions, procedures, proposals, methods, and/or operational flowcharts disclosed in this document. For example, the processor(s) (202) may process information within the memory(s) (204) to generate third information/signals and then transmit radio signals including the third information/signals through the transceiver(s) (206). The processor(s) (202) may receive radio signals including fourth information/signals through the transceiver(s) (106) and then store information obtained by processing the fourth information/signals in the memory(s) (204). The memory(s) (204) may be connected to the processor(s) (202) and may store various information related to operations of the processor(s) (202). For example, the memory(s) (204) may store software code including commands for performing a part or the entirety of processes controlled by the processor(s) (202) or for performing the descriptions, functions, procedures, proposals, methods, and/or operational flowcharts disclosed in this document. Herein, the processor(s) (202) and the memory(s) (204) may be a part of a communication modem/circuit/chip designed to implement RAT (e.g., LTE or NR). The transceiver(s) (206) may be connected to the processor(s) (202) and transmit and/or receive radio signals through one or more antennas (208). Each of the transceiver(s) (206) may include a transmitter and/or a receiver. The transceiver(s) (206) may be interchangeably used with RF unit(s). In the present disclosure, the wireless device may represent a communication modem/circuit/chip.

Hereinafter, hardware elements of the wireless devices (100, 200) will be described more specifically. One or more protocol layers may be implemented by, without being limited to, one or more processors (102, 202). For example, the one or more processors (102, 202) may implement one or more layers (e.g., functional layers such as PHY, MAC, RLC, PDCP, RRC, and SDAP). The one or more processors (102, 202) may generate one or more Protocol Data Units (PDUs) and/or one or more Service Data Unit (SDUs) according to the descriptions, functions, procedures, proposals, methods, and/or operational flowcharts disclosed in this document. The one or more processors (102, 202) may generate messages, control information, data, or information according to the descriptions, functions, procedures, proposals, methods, and/or operational flowcharts disclosed in this document. The one or more processors (102, 202) may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers (106, 206). The one or more processors (102, 202) may receive the signals (e.g., baseband signals) from the one or more transceivers (106, 206) and obtain the PDUs, SDUs, messages, control information, data, or information according to the descriptions, functions, procedures, proposals, methods, and/or operational flowcharts disclosed in this document.

The one or more processors (102, 202) may be referred to as controllers, microcontrollers, microprocessors, or microcomputers. The one or more processors (102, 202) may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors (102, 202). The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors (102, 202) or stored in the one or more memories (104, 204) so as to be driven by the one or more processors (102, 202). The descriptions, functions, procedures, proposals, methods, and/or operational flowcharts disclosed in this document may be implemented using firmware or software in the form of code, commands, and/or a set of commands.

The one or more memories (104, 204) may be connected to the one or more processors (102, 202) and store various types of data, signals, messages, information, programs, code, instructions, and/or commands. The one or more memories (104, 204) may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories (104, 204) may be located at the interior and/or exterior of the one or more processors (102, 202). The one or more memories (104, 204) may be connected to the one or more processors (102, 202) through various technologies such as wired or wireless connection.

The one or more transceivers (106, 206) may transmit user data, control information, and/or radio signals/channels, mentioned in the methods and/or operational flowcharts of this document, to one or more other devices. The one or more transceivers (106, 206) may receive user data, control information, and/or radio signals/channels, mentioned in the descriptions, functions, procedures, proposals, methods, and/or operational flowcharts disclosed in this document, from one or more other devices. For example, the one or more transceivers (106, 206) may be connected to the one or more processors (102, 202) and transmit and receive radio signals. For example, the one or more processors (102, 202) may perform control so that the one or more transceivers (106, 206) may transmit user data, control information, or radio signals to one or more other devices. The one or more processors (102, 202) may perform control so that the one or more transceivers (106, 206) may receive user data, control information, or radio signals from one or more other devices. The one or more transceivers (106, 206) may be connected to the one or more antennas (108, 208) and the one or more transceivers (106, 206) may be configured to transmit and receive user data, control information, and/or radio signals/channels, mentioned in the descriptions, functions, procedures, proposals, methods, and/or operational flowcharts disclosed in this document, through the one or more antennas (108, 208). In this document, the one or more antennas may be a plurality of physical antennas or a plurality of logical antennas (e.g., antenna ports). The one or more transceivers (106, 206) may convert received radio signals/channels, etc., from RF band signals into baseband signals in order to process received user data, control information, radio signals/channels, etc., using the one or more processors (102, 202). The one or more transceivers (106, 206) may convert the user data, control information, radio signals/channels, etc., processed using the one or more processors (102, 202) from the base band signals into the RF band signals. To this end, the one or more transceivers (106, 206) may include (analog) oscillators and/or filters.

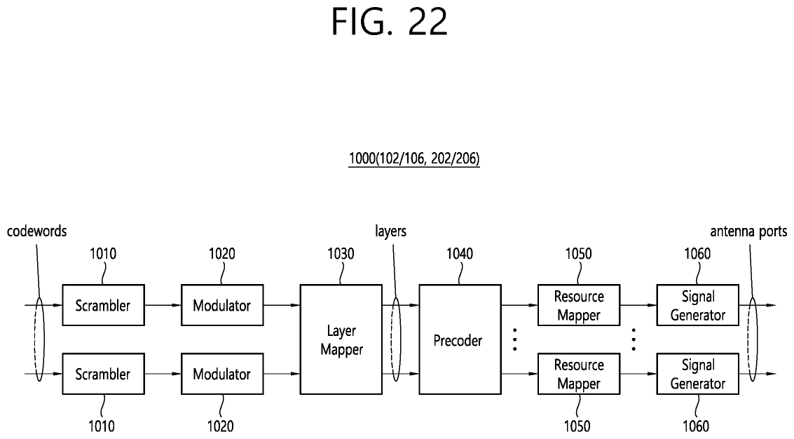

FIG. 22 shows a signal process circuit for a transmission signal in accordance with an embodiment of the present disclosure.

Referring to FIG. 22, a signal processing circuit (1000) may include scramblers (1010), modulators (1020), a layer mapper (1030), a precoder (1040), resource mappers (1050), and signal generators (1060). An operation/function of FIG. 22 may be performed, without being limited to, the processors (102, 202) and/or the transceivers (106, 206) of FIG. 21. Hardware elements of FIG. 22 may be implemented by the processors (102, 202) and/or the transceivers (106, 206) of FIG. 21. For example, blocks 1010˜1060 may be implemented by the processors (102, 202) of FIG. 21. Alternatively, the blocks 1010˜1050 may be implemented by the processors (102, 202) of FIG. 21 and the block 1060 may be implemented by the transceivers (106, 206) of FIG. 21.

Codewords may be converted into radio signals via the signal processing circuit (1000) of FIG. 22. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers (1010). Scramble sequences used for scrambling may be generated based on an initialization value, and the initialization value may include ID information of a wireless device. The scrambled bit sequences may be modulated to modulation symbol sequences by the modulators (1020). A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper (1030). Modulation symbols of each transport layer may be mapped (precoded) to corresponding antenna port(s) by the precoder (1040). Outputs z of the precoder (1040) may be obtained by multiplying outputs y of the layer mapper (1030) by an N*M precoding matrix W. Herein, N is the number of antenna ports and M is the number of transport layers. The precoder (1040) may perform precoding after performing transform precoding (e.g., DFT) for complex modulation symbols. Alternatively, the precoder (1040) may perform precoding without performing transform precoding.

The resource mappers (1050) may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators (1060) may generate radio signals from the mapped modulation symbols and the generated radio signals may be transmitted to other devices through each antenna. For this purpose, the signal generators (1060) may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures (1010˜1060) of FIG. 22. For example, the wireless devices (e.g., 100, 200 of FIG. 21) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

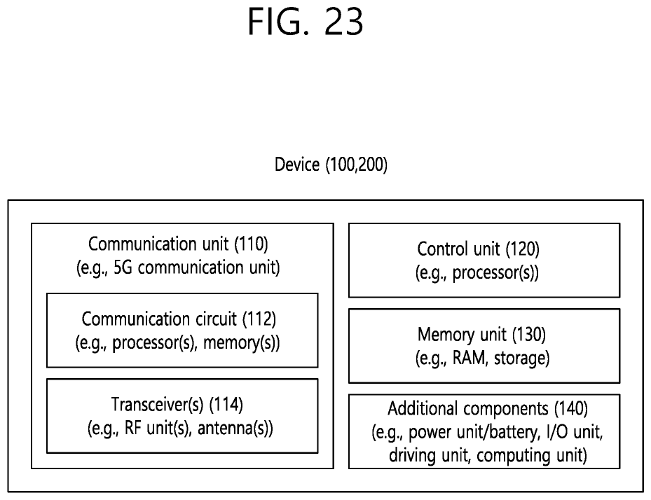

FIG. 23 shows another example of a wireless device in accordance with an embodiment of the present disclosure. The wireless device may be implemented in various forms according to a use-case/service (refer to FIG. 20).

Referring to FIG. 23, wireless devices (100, 200) may correspond to the wireless devices (100, 200) of FIG. 21 and may be configured by various elements, components, units/portions, and/or modules. For example, each of the wireless devices (100, 200) may include a communication unit (110), a control unit (120), a memory unit (130), and additional components (140). The communication unit may include a communication circuit (112) and transceiver(s) (114). For example, the communication circuit (112) may include the one or more processors (102, 202) and/or the one or more memories (104, 204) of FIG. 21. For example, the transceiver(s) (114) may include the one or more transceivers (106, 206) and/or the one or more antennas (108, 208) of FIG. 21. The control unit (120) is electrically connected to the communication unit (110), the memory (130), and the additional components (140) and controls overall operation of the wireless devices. For example, the control unit (120) may control an electric/mechanical operation of the wireless device based on programs/code/commands/information stored in the memory unit (130). The control unit (120) may transmit the information stored in the memory unit (130) to the exterior (e.g., other communication devices) via the communication unit (110) through a wireless/wired interface or store, in the memory unit (130), information received through the wireless/wired interface from the exterior (e.g., other communication devices) via the communication unit (110).

The additional components (140) may be variously configured according to types of wireless devices. For example, the additional components (140) may include at least one of a power unit/battery, input/output (I/O) unit, a driving unit, and a computing unit. The wireless device may be implemented in the form of, without being limited to, the robot (100a of FIG. 20), the vehicles (100b-1 and 100b-2 of FIG. 20), the XR device (100c of FIG. 20), the hand-held device (100d of FIG. 20), the home appliance (100e of FIG. 20), the IoT device (100f of FIG. 20), a digital broadcast terminal, a hologram device, a public safety device, an MTC device, a medicine device, a fintech device (or a finance device), a security device, a climate/environment device, the AI server/device (400 of FIG. 20), the BSs (200 of FIG. 20), a network node, etc. The wireless device may be used in a mobile or fixed place according to a use-example/service.

In FIG. 23, the entirety of the various elements, components, units/portions, and/or modules in the wireless devices (100, 200) may be connected to each other through a wired interface or at least a part thereof may be wirelessly connected through the communication unit (110). For example, in each of the wireless devices (100, 200), the control unit (120) and the communication unit (110) may be connected by wire and the control unit (120) and first units (e.g., 130, 140) may be wirelessly connected through the communication unit (110). Each element, component, unit/portion, and/or module within the wireless devices (100, 200) may further include one or more elements. For example, the control unit (120) may be configured by a set of one or more processors. As an example, the control unit (120) may be configured by a set of a communication control processor, an application processor, an Electronic Control Unit (ECU), a graphical processing unit, and a memory control processor. As another example, the memory (130) may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 23 will be described in detail with reference to the drawings.

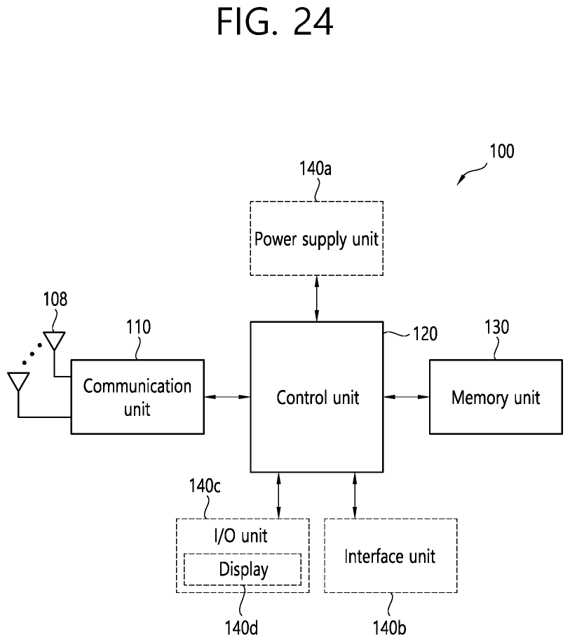

FIG. 24 shows a hand-held device in accordance with an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 24, a hand-held device (100) may include an antenna unit (108), a communication unit (110), a control unit (120), a memory unit (130), a power supply unit (140a), an interface unit (140b), and an I/O unit (140c). The antenna unit (108) may be configured as a part of the communication unit (110). Blocks 110˜130/140a˜140c correspond to the blocks 110˜130/140 of FIG. 23, respectively.

The communication unit (110) may transmit and receive signals (e.g., data and control signals) to and from other wireless devices or BSs. The control unit (120) may perform various operations by controlling constituent elements of the hand-held device (100). The control unit (120) may include an Application Processor (AP). The memory unit (130) may store data/parameters/programs/code/commands needed to drive the hand-held device (100). The memory unit (130) may store input/output data/information. The power supply unit (140a) may supply power to the hand-held device (100) and include a wired/wireless charging circuit, a battery, etc. The interface unit (140b) may support connection of the hand-held device (100) to other external devices. The interface unit (140b) may include various ports (e.g., an audio I/O port and a video I/O port) for connection with external devices. The I/O unit (140c) may input or output video information/signals, audio information/signals, data, and/or information input by a user. The I/O unit (140c) may include a camera, a microphone, a user input unit, a display unit (140d), a speaker, and/or a haptic module.

As an example, in the case of data communication, the I/O unit (140c) may obtain information/signals (e.g., touch, text, voice, images, or video) input by a user and the obtained information/signals may be stored in the memory unit (130). The communication unit (110) may convert the information/signals stored in the memory into radio signals and transmit the converted radio signals to other wireless devices directly or to a BS. The communication unit (110) may receive radio signals from other wireless devices or the BS and then restore the received radio signals into original information/signals. The restored information/signals may be stored in the memory unit (130) and may be output as various types (e.g., text, voice, images, video, or haptic) through the I/O unit (140c).

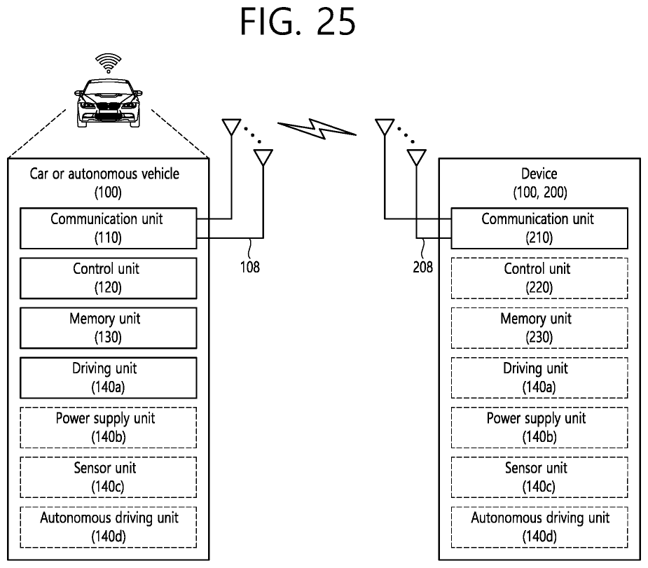

FIG. 25 shows a vehicle or an autonomous vehicle in accordance with an embodiment of the present disclosure. The vehicle or autonomous vehicle may be implemented by a mobile robot, a car, a train, a manned/unmanned Aerial Vehicle (AV), a ship, etc.

Referring to FIG. 25, a vehicle or autonomous vehicle (100) may include an antenna unit (108), a communication unit (110), a control unit (120), a driving unit (140a), a power supply unit (140b), a sensor unit (140c), and an autonomous driving unit (140d). The antenna unit (108) may be configured as a part of the communication unit (110). The blocks 110/130/140a˜140d correspond to the blocks 110/130/140 of FIG. 23, respectively.

The communication unit (110) may transmit and receive signals (e.g., data and control signals) to and from external devices such as other vehicles, BSs (e.g., gNBs and road side units), and servers. The control unit (120) may perform various operations by controlling elements of the vehicle or the autonomous vehicle (100). The control unit (120) may include an Electronic Control Unit (ECU). The driving unit (140a) may cause the vehicle or the autonomous vehicle (100) to drive on a road. The driving unit (140a) may include an engine, a motor, a powertrain, a wheel, a brake, a steering device, etc. The power supply unit (140b) may supply power to the vehicle or the autonomous vehicle (100) and include a wired/wireless charging circuit, a battery, etc. The sensor unit (140c) may obtain a vehicle state, ambient environment information, user information, etc. The sensor unit (140c) may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit (140d) may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit (110) may receive map data, traffic information data, etc., from an external server. The autonomous driving unit (140d) may generate an autonomous driving path and a driving plan from the obtained data. The control unit (120) may control the driving unit (140a) such that the vehicle or the autonomous vehicle (100) may move along the autonomous driving path according to the driving plan (e.g., speed/direction control). In the middle of autonomous driving, the communication unit (110) may aperiodically/periodically obtain recent traffic information data from the external server and obtain surrounding traffic information data from neighboring vehicles. In the middle of autonomous driving, the sensor unit (140c) may obtain a vehicle state and/or surrounding environment information. The autonomous driving unit (140d) may update the autonomous driving path and the driving plan based on the newly obtained data/information. The communication unit (110) may transfer information on a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

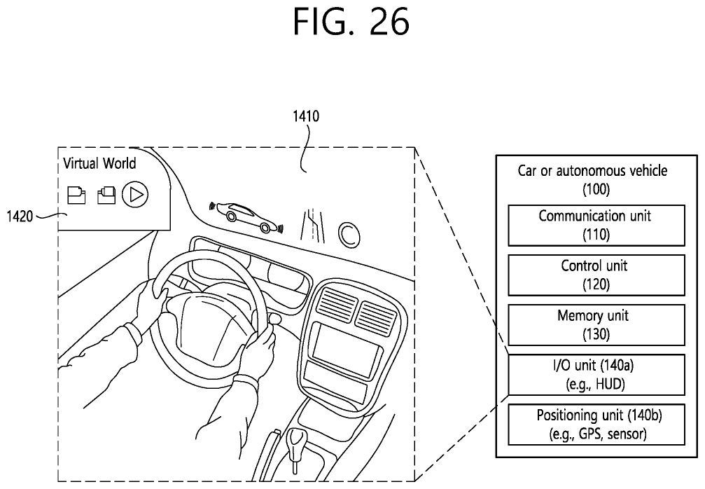

FIG. 26 shows a vehicle in accordance with an embodiment of the present disclosure. The vehicle may be implemented as a transport means, an aerial vehicle, a ship, etc.

Referring to FIG. 26, a vehicle (100) may include a communication unit (110), a control unit (120), a memory unit (130), an I/O unit (140a), and a positioning unit (140b). Herein, the blocks 110˜130/140a˜140b correspond to blocks 110˜130/140 of FIG. 23.

The communication unit (110) may transmit and receive signals (e.g., data and control signals) to and from external devices such as other vehicles or BSs. The control unit (120) may perform various operations by controlling constituent elements of the vehicle (100). The memory unit (130) may store data/parameters/programs/code/commands for supporting various functions of the vehicle (100). The I/O unit (140a) may output an AR/VR object based on information within the memory unit (130). The I/O unit (140a) may include an HUD. The positioning unit (140b) may obtain information on the position of the vehicle (100). The position information may include information on an absolute position of the vehicle (100), information on the position of the vehicle (100) within a traveling lane, acceleration information, and information on the position of the vehicle (100) from a neighboring vehicle. The positioning unit (140b) may include a GPS and various sensors.

As an example, the communication unit (110) of the vehicle (100) may receive map information and traffic information from an external server and store the received information in the memory unit (130). The positioning unit (140b) may obtain the vehicle position information through the GPS and various sensors and store the obtained information in the memory unit (130). The control unit (120) may generate a virtual object based on the map information, traffic information, and vehicle position information and the I/O unit (140a) may display the generated virtual object in a window in the vehicle (1410, 1420). The control unit (120) may determine whether the vehicle (100) normally drives within a traveling lane, based on the vehicle position information. If the vehicle (100) abnormally exits from the traveling lane, the control unit (120) may display a warning on the window in the vehicle through the I/O unit (140a). In addition, the control unit (120) may broadcast a warning message regarding driving abnormity to neighboring vehicles through the communication unit (110). According to situation, the control unit (120) may transmit the vehicle position information and the information on driving/vehicle abnormality to related organizations.

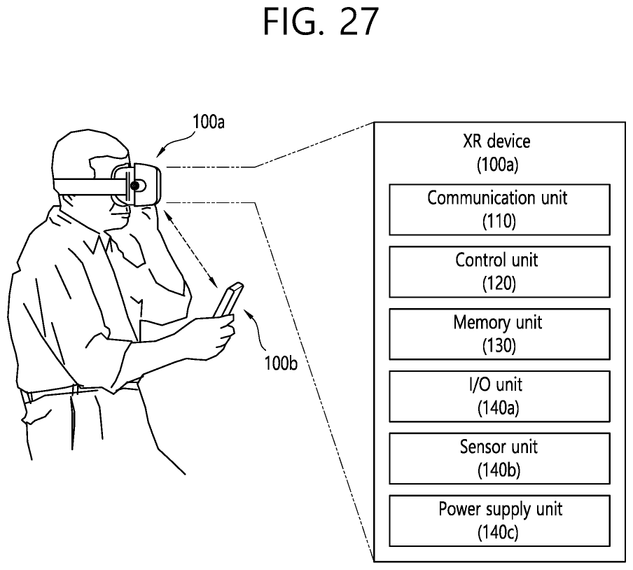

FIG. 27 shows an XR device in accordance with an embodiment of the present disclosure. The XR device may be implemented by an HMD, an HUD mounted in a vehicle, a television, a smartphone, a computer, a wearable device, a home appliance, a digital signage, a vehicle, a robot, etc.

Referring to FIG. 27, an XR device (100a) may include a communication unit (110), a control unit (120), a memory unit (130), an I/O unit (140a), a sensor unit (140b), and a power supply unit (140c). Herein, the blocks 110˜130/140a˜140c correspond to the blocks 110˜130/140 of FIG. 23, respectively.

The communication unit (110) may transmit and receive signals (e.g., media data and control signals) to and from external devices such as other wireless devices, hand-held devices, or media servers. The media data may include video, images, and sound. The control unit (120) may perform various operations by controlling constituent elements of the XR device (100a). For example, the control unit (120) may be configured to control and/or perform procedures such as video/image acquisition, (video/image) encoding, and metadata generation and processing. The memory unit (130) may store data/parameters/programs/code/commands needed to drive the XR device (100a)/generate XR object. The I/O unit (140a) may obtain control information and data from the exterior and output the generated XR object. The I/O unit (140a) may include a camera, a microphone, a user input unit, a display unit, a speaker, and/or a haptic module. The sensor unit (140b) may obtain an XR device state, surrounding environment information, user information, etc. The sensor unit (140b) may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone and/or a radar. The power supply unit (140c) may supply power to the XR device (100a) and include a wired/wireless charging circuit, a battery, etc.

For example, the memory unit (130) of the XR device (100a) may include information (e.g., data) needed to generate the XR object (e.g., an AR/VR/MR object). The I/O unit (140a) may receive a command for manipulating the XR device (100a) from a user and the control unit (120) may drive the XR device (100a) according to a driving command of a user. For example, when a user desires to watch a film or news through the XR device (100a), the control unit (120) transmits content request information to another device (e.g., a hand-held device (100b)) or a media server through the communication unit (130). The communication unit (130) may download/stream content such as films or news from another device (e.g., the hand-held device (100b)) or the media server to the memory unit (130). The control unit (120) may control and/or perform procedures such as video/image acquisition, (video/image) encoding, and metadata generation/processing with respect to the content and generate/output the XR object based on information on a surrounding space or a real object obtained through the I/O unit (140a)/sensor unit (140b).

The XR device (100a) may be wirelessly connected to the hand-held device (100b) through the communication unit (110) and the operation of the XR device (100a) may be controlled by the hand-held device (100b). For example, the hand-held device (100b) may operate as a controller of the XR device (100a). To this end, the XR device (100a) may obtain information on a 3D position of the hand-held device (100b) and generate and output an XR object corresponding to the hand-held device (100b).

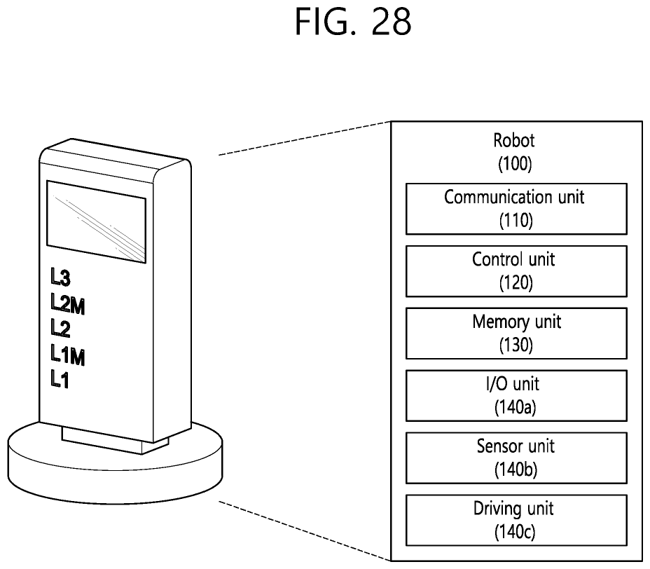

FIG. 28 shows a robot in accordance with an embodiment of the present disclosure. The robot may be categorized into an industrial robot, a medical robot, a household robot, a military robot, etc., according to a used purpose or field.

Referring to FIG. 28, a robot (100) may include a communication unit (110), a control unit (120), a memory unit (130), an I/O unit (140a), a sensor unit (140b), and a driving unit (140c). Herein, the blocks 110˜130/140a˜140c correspond to the blocks 110˜130/140 of FIG. 23, respectively.

The communication unit (110) may transmit and receive signals (e.g., driving information and control signals) to and from external devices such as other wireless devices, other robots, or control servers. The control unit (120) may perform various operations by controlling constituent elements of the robot (100). The memory unit (130) may store data/parameters/programs/code/commands for supporting various functions of the robot (100). The I/O unit (140a) may obtain information from the exterior of the robot (100) and output information to the exterior of the robot (100). The I/O unit (140a) may include a camera, a microphone, a user input unit, a display unit, a speaker, and/or a haptic module. The sensor unit (140b) may obtain internal information of the robot (100), surrounding environment information, user information, etc. The sensor unit (140b) may include a proximity sensor, an illumination sensor, an acceleration sensor, a magnetic sensor, a gyro sensor, an inertial sensor, an IR sensor, a fingerprint recognition sensor, an ultrasonic sensor, a light sensor, a microphone, a radar, etc. The driving unit (140c) may perform various physical operations such as movement of robot joints. In addition, the driving unit (140c) may cause the robot (100) to travel on the road or to fly. The driving unit (140c) may include an actuator, a motor, a wheel, a brake, a propeller, etc.

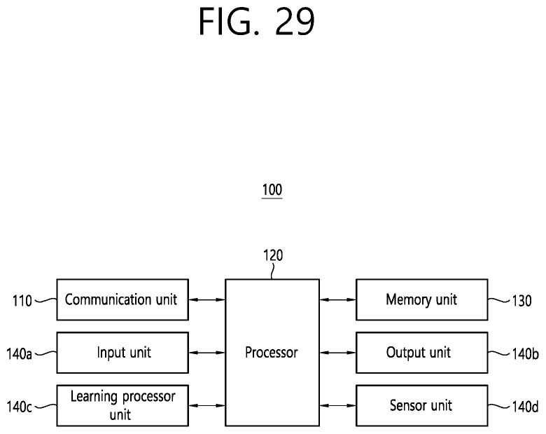

FIG. 29 shows an AI device in accordance with an embodiment of the present disclosure. The AI device may be implemented by a fixed device or a mobile device, such as a TV, a projector, a smartphone, a PC, a notebook, a digital broadcast terminal, a tablet PC, a wearable device, a Set Top Box (STB), a radio, a washing machine, a refrigerator, a digital signage, a robot, a vehicle, etc.

Referring to FIG. 29, an AI device (100) may include a communication unit (110), a control unit (120), a memory unit (130), an I/O unit (140a/140b), a learning processor unit (140c), and a sensor unit (140d). The blocks 110˜130/140a˜140d correspond to blocks 110˜130/140 of FIG. 23, respectively.

The communication unit (110) may transmit and receive wired/radio signals (e.g., sensor information, user input, learning models, or control signals) to and from external devices such as other AI devices (e.g., 100x, 200, or 400 of FIG. 20) or an AI server (e.g., 400 of FIG. 20) using wired/wireless communication technology. To this end, the communication unit (110) may transmit information within the memory unit (130) to an external device and transmit a signal received from the external device to the memory unit (130).

The control unit (120) may determine at least one feasible operation of the AI device (100), based on information which is determined or generated using a data analysis algorithm or a machine learning algorithm. The control unit (120) may perform an operation determined by controlling constituent elements of the AI device (100). For example, the control unit (120) may request, search, receive, or use data of the learning processor unit (140c) or the memory unit (130) and control the constituent elements of the AI device (100) to perform a predicted operation or an operation determined to be preferred among at least one feasible operation. The control unit (120) may collect history information including the operation contents of the AI device (100) and operation feedback by a user and store the collected information in the memory unit (130) or the learning processor unit (140c) or transmit the collected information to an external device such as an AI server (400 of FIG. 20). The collected history information may be used to update a learning model.

The memory unit (130) may store data for supporting various functions of the AI device (100). For example, the memory unit (130) may store data obtained from the input unit (140a), data obtained from the communication unit (110), output data of the learning processor unit (140c), and data obtained from the sensor unit (140). The memory unit (130) may store control information and/or software code needed to operate/drive the control unit (120).

The input unit (140a) may obtain various types of data from the exterior of the AI device (100). For example, the input unit (140a) may obtain learning data for model learning, and input data to which the learning model is to be applied. The input unit (140a) may include a camera, a microphone, and/or a user input unit. The output unit (140b) may generate output related to a visual, auditory, or tactile sense. The output unit (140b) may include a display unit, a speaker, and/or a haptic module. The sensing unit (140) may obtain at least one of internal information of the AI device (100), surrounding environment information of the AI device (100), and user information, using various sensors. The sensor unit (140) may include a proximity sensor, an illumination sensor, an acceleration sensor, a magnetic sensor, a gyro sensor, an inertial sensor, an RGB sensor, an IR sensor, a fingerprint recognition sensor, an ultrasonic sensor, a light sensor, a microphone, and/or a radar.

The learning processor unit (140c) may learn a model consisting of artificial neural networks, using learning data. The learning processor unit (140c) may perform AI processing together with the learning processor unit of the AI server (400 of FIG. 20). The learning processor unit (140c) may process information received from an external device through the communication unit (110) and/or information stored in the memory unit (130). In addition, an output value of the learning processor unit (140c) may be transmitted to the external device through the communication unit (110) and may be stored in the memory unit (130).

Claims in the present description can be combined in various ways. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

What is claimed is:

1. A method for performing transmission by a first device (100), the method comprising:
determining a number of frequencies related to transmission of first information based on a delay deadline of the first information; and
transmitting the first information to a second device (200) on one or more frequencies.

2. The method of claim 1, further comprising:
determining a first difference value between the delay deadline and a time point at which transmission of the first information is determined.

3. The method of claim 2, wherein the first information is transmitted on one frequency based on the first difference value greater than or equal to a threshold value.

4. The method of claim 2, wherein the first information is transmitted on a plurality of frequencies based on the first difference value less than or equal to a threshold value.

5. The method of claim 2, further comprising:
determining a second difference value between a time point at which transmission of the first information is determined and a time point at which retransmission of the first information is performed based on feedback from the second device.

6. The method of claim 5, wherein the first information is transmitted on one frequency based on the second difference value that is less than the first difference value.

7. The method of claim 5, wherein the first information is transmitted on a plurality of frequencies based on the second difference value that is greater than or equal to the first difference value.

8. The method of claim 7, wherein the first information transmitted on each of the plurality of frequencies is a same information.

9. The method of claim 1, wherein the first information is sidelink information, uplink information, or downlink information.

10. The method of claim 1, wherein the number of frequencies related to transmission of the first information is determined based on a QoS requirement or a reliability requirement of the first information.

11. The method of claim 10, wherein a number of frequencies related to transmission of information having low QoS requirement or low reliability requirement is less than a number of frequencies related to transmission of information having high QoS requirement or high reliability requirement.

12. The method of claim 1, wherein a QoS requirement or a reliability requirement of the first information is greater than a threshold value.

13. The method of claim 1, wherein the first information is transmitted on one frequency based on a QoS requirement or a reliability requirement of the first information less than a threshold value.

14. The method of claim 1, wherein the first information is transmitted on the one or more frequencies by being duplicated in L2 layer of the first device (100).

15. A first device (100) performing transmission, the first device (100) comprising:
one or more memories; one or more transceivers; and one or more processors connected to the one or more memories and the one or more transceivers, wherein the one or more processors are configured to:
determine a number of frequencies related to transmission of first information based on a delay deadline of the first information; and
transmit the first information to a second device (200) on one or more frequencies.
